(19) United States
(12) Patent Application Publication
(10) Pub. No.: US 2023/0245423 A1
(43) Pub. Date: Aug. 3, 2023

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventor: TAKAHIRO HIRANO, KANAGAWA (JP)

(21) Appl. No.: 18/002,690

(22) PCT Filed: Jun. 18, 2021
(86) PCT No.: PCT/JP2021/023154

§ 371 Date: Dec. 21, 2022

(30) Foreign Application Priority Data
Jul. 2, 2020 (JP) 2020-114867

(51) Int. Cl. G06V 10/764; G06V 10/48

(52) U.S. Cl. CPC G06V 10/764; G06V 10/48; G01S 13/867

(57) ABSTRACT

The present technique relates to an information processing apparatus, an information processing method, and a program that enable recognition accuracy to be improved while suppressing an increase in load in object recognition using a CNN.

An information processing apparatus: performs, a plurality of times, convolution of an image feature map representing a feature amount of an image of a first frame and generates a convolutional feature map of a plurality of layers; performs deconvolution of a feature map based on the convolutional feature map based on an image of a second frame preceding the first frame and generates a deconvolutional feature map; and performs object recognition based on the convolutional feature map based on an image of the first frame and on the deconvolutional feature map based on an image of the second frame. The present technique can be applied to, for example, a system which performs object recognition.

### TECHNICAL FIELD

The present technique relates to an information processing apparatus, an information processing method, and a program, and more particularly, to an information processing apparatus, an information processing method, and a program which perform object recognition using a convolutional neural network.

### BACKGROUND ART

Conventionally, various methods of object recognition using a convolutional neural network (CNN) have been proposed. For example, a technique is proposed in which convolution is respectively performed on a present frame and a past frame of a video, a present feature map and a past feature map are calculated, and an object candidate region is estimated using a feature map combining the present feature map and the past feature map (for example, refer to PTL 1).

### CITATION LIST

### Patent Literature

### [PTL 1]

JP 2018-77829A

### SUMMARY

### Technical Problem

However, in the invention described in PTL 1, since convolutions of a present frame and a past frame are performed simultaneously performed, there is a risk of an increase in load.

The present technique has been devised in view of such circumstances and an object thereof is to improve recognition accuracy while suppressing an increase in load in object recognition using a CNN.

### Solution to Problem

An information processing apparatus according to an aspect of the present technique includes: a convoluting portion configured to perform, a plurality of times, convolution of an image feature map representing a feature amount of an image and to generate a convolutional feature map of a plurality of layers; a deconvoluting portion configured to perform deconvolution of a feature map based on the convolutional feature map and to generate a deconvolutional feature map; and a recognizing portion configured to perform object recognition based on the convolutional feature map and the deconvolutional feature map, wherein the convoluting portion is configured to perform, a plurality of times, convolution of the image feature map representing a feature amount of an image of a first frame and to generate the convolutional feature map of a plurality of layers; the deconvoluting portion is configured to perform deconvolution of a feature map based on the convolutional feature map based on an image of a second frame preceding the first frame and to generate the deconvolutional feature map, and the recognizing portion is configured to perform object recognition based on the convolutional feature map based on an image of the first frame and on the deconvolutional feature map based on an image of the second frame.

An information processing method according to an aspect of the present technique includes the steps of: performing, a plurality of times, convolution of an image feature map representing a feature amount of an image of a first frame and generating a convolutional feature map of a plurality of layers; performing deconvolution of a feature map based on the convolutional feature map based on an image of a second frame preceding the first frame and generating a deconvolutional feature map; and performing object recognition based on the convolutional feature map based on an image of the first frame and on the deconvolutional feature map based on an image of the second frame.

A program according to an aspect of the present technique: performs, a plurality of times, convolution of an image feature map representing a feature amount of an image of a first frame and generates a convolutional feature map of a plurality of layers; performs deconvolution of a feature map based on the convolutional feature map based on an image of a second frame preceding the first frame and generates a deconvolutional feature map; and performs object recognition based on the convolutional feature map based on an image of the first frame and on the deconvolutional feature map based on an image of the second frame.

In an aspect of the present technique: convolution of an image feature map representing a feature amount of an image of a first frame is performed a plurality of times and a convolutional feature map of a plurality of layers is generated; deconvolution of a feature map based on the convolutional feature map based on an image of a second frame preceding the first frame is performed and a deconvolutional feature map is generated; and object recognition is performed based on the convolutional feature map based on an image of the first frame and on the deconvolutional feature map based on an image of the second frame.

### BRIEF DESCRIPTION OF DRAWINGS

FIG. 1 is a block diagram showing a configuration example of a vehicle control system.

FIG. 2 is a diagram showing an example of sensing areas.

FIG. 3 is a block diagram showing a first embodiment of an information processing system to which the present technique is applied.

FIG. 4 is a block diagram showing a first embodiment of an object recognizing portion shown in FIG. 3.

FIG. 5 is a flowchart for explaining object recognition processing to be executed by the information processing system shown in FIG. 3.

FIG. 6 is a diagram for explaining a specific example of object recognition processing by the object recognizing portion shown in FIG. 4.

FIG. 7 is a diagram for explaining a specific example of object recognition processing by the object recognizing portion shown in FIG. 4.

FIG. 8 is a block diagram showing a second embodiment of the object recognizing portion shown in FIG. 3.

FIG. 9 is a diagram for explaining a specific example of object recognition processing by the object recognizing portion shown in FIG. 8.

FIG. 10 is a diagram for explaining a specific example of object recognition processing by the object recognizing portion shown in FIG. 8.

FIG. 11 is a block diagram showing a second embodiment of the information processing system to which the present technique is applied.

FIG. 12 is a block diagram showing a third embodiment of the information processing system to which the present technique is applied.

FIG. 13 is a block diagram showing a fourth embodiment of the information processing system to which the present technique is applied.

FIG. 14 is a block diagram showing a configuration example of a computer.

### DESCRIPTION OF EMBODIMENTS

Embodiments for implementing the present technique will be described below. The description will be given in the following order.
1. Configuration example of vehicle control system
2. First embodiment (example of not successively performing deconvolutions)
3. Second embodiment (example enabling successive deconvolutions to be performed)
4. Third embodiment (first example of combining a camera and a milliwave radar)
5. Fourth embodiment (example of combining a camera, a milliwave radar, and LiDAR)
6. Fifth embodiment (second example of combining a camera and a milliwave radar)
7. Modifications
8. Others

### 1. Configuration Example of Vehicle Control System

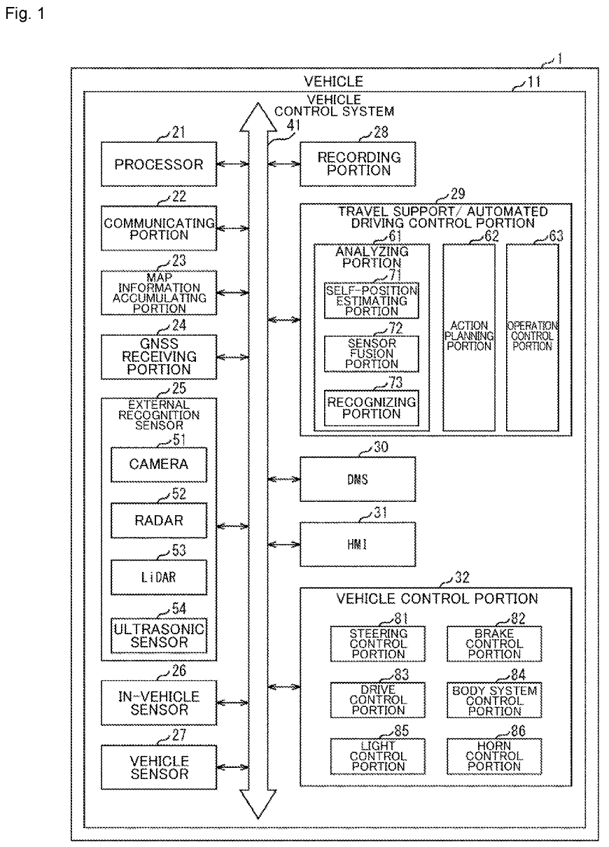

FIG. 1 is a block diagram showing a configuration example of a vehicle control system 11 being an example of a mobile apparatus control system to which the present technique is to be applied.

The vehicle control system 11 is provided in a vehicle 1 and performs processing related to travel support and automated driving of the vehicle 1.

The vehicle control system 11 includes a processor 21, a communicating portion 22, a map information accumulating portion 23, a GNSS (Global Navigation Satellite System) receiving portion 24, an external recognition sensor 25, an in-vehicle sensor 26, a vehicle sensor 27, a recording portion 28, a travel support/ automated driving control portion 29, a DMS (Driver Monitoring System) 30, an HMI (Human Machine Interface) 31, and a vehicle control portion 32.

The processor 21, the communicating portion 22, the map information accumulating portion 23, the GNSS receiving portion 24, the external recognition sensor 25, the in-vehicle sensor 26, the vehicle sensor 27, the recording portion 28, the travel support/ automated driving control portion 29, the driver monitoring system (DMS) 30, the human machine interface (HMI) 31, and the vehicle control portion 32 are connected to each other via a communication network 41. The communication network 41 is constituted of a vehicle-mounted communication network in conformity with any standard such as a CAN (Controller Area Network), a LIN (Local Interconnect Network), a LAN (Local Area Network), FlexRay (registered trademark), or Ethernet (registered trademark), a bus, and the like. Alternatively, each portion of the vehicle control system 11 may be directly connected by near field communication (NFC), Bluetooth (registered trademark), or the like without involving the communication network 41.

Hereinafter, when each portion of the vehicle control system 11 is to communicate via the communication network 41, a description of the communication network 41 will be omitted. For example, communication performed between the processor 21 and the communicating portion 22 via the communication network 41 will simply be referred to as communication performed between the processor 21 and the communicating portion 22.

The processor 21 is constituted of a processor of various types such as a CPU (Central Processing Unit), an MPU (Micro Processing Unit), or an ECU (Electronic Control Unit). The processor 21 controls the vehicle control system 11 as a whole.

The communicating portion 22 communicates with various devices inside and outside the vehicle, other vehicles, servers, base stations, and the like and transmits and receives various kinds of data. As communication with outside of the vehicle, for example, the communicating portion 22 receives a program for updating software that controls operations of the vehicle control system 11, map information, traffic information, information on surroundings of the vehicle 1, and the like from the outside. For example, the communicating portion 22 transmits information related to the vehicle 1 (for example, data representing a state of the vehicle 1, a recognition result by a recognizing portion 73, and the like), information on surroundings of the vehicle 1, and the like to the outside. For example, the communicating portion 22 performs communication accommodating a vehicle emergency notification system such as eCall.

A communication method adopted by the communicating portion 22 is not particularly limited. In addition, a plurality of communication methods may be used.

As communication with the inside of the vehicle, for example, the communicating portion 22 performs wireless communication with devices inside the vehicle according to a communication method such as wireless LAN, Bluetooth, NFC, WUSB (Wireless USB), or the like. For example, the communicating portion 22 performs wired communication with devices inside the vehicle according to a communication method such as USB (Universal Serial Bus), HDMI (High-Definition Multimedia Interface, registered trademark), or MHL (Mobile High-definition Link) via a connection terminal (not illustrated) (and a cable if necessary).

In this case, a device in the vehicle is, for example, a device not connected to the communication network 41 in the vehicle. For example, a mobile device or a wearable device carried by an occupant such as a driver or an information device which is carried aboard the vehicle to be temporarily installed therein is assumed.

For example, the communicating portion 22 communicates with a server or the like that is present on an external network (for example, the Internet, a cloud network, or a business-specific network) according to a wireless communication method such as 4G (4th Generation Mobile Communication System), 5G (5th Generation Mobile Communication System), LTE (Long Term Evolution), or DSRC (Dedicated Short Range Communications) via a base station or an access point.

For example, the communicating portion 22 communicates with a terminal present in a vicinity of its own vehicle (for example, a terminal carried by a pedestrian or a terminal at a store, or an MTC (Machine Type Communication) terminal) using P2P (Peer To Peer) technology. For example, the communicating portion 22 performs V2X communication. Examples of V2X communication include Vehicle-to-Vehicle communication with another vehicle, Vehicle-to-Infrastructure communication with a roadside device or the like, Vehicle-to-Home communication with home, and Vehicle-to-Pedestrian communication with a terminal owned by a pedestrian or the like.

For example, the communicating portion 22 receives electromagnetic waves transmitted by a Vehicle Information and Communication System (VICS (registered trademark)) using a radio beacon, a light beacon, FM multiplex broadcast, and the like.

The map information accumulating portion 23 accumulates maps acquired from the outside and maps created by the vehicle 1. For example, the map information accumulating portion 23 accumulates a three-dimensional high-precision map, a global map which is less precise than the high-precision map but which covers a wide area, and the like.

The high-precision map is, for example, a dynamic map, a point cloud map, a vector map (also referred to as an ADAS (Advanced Driver Assistance System) map), or the like. A dynamic map is a map which is made up of four layers of dynamic information, quasi-dynamic information, quasi-static information, and static information and which is provided by an external server or the like. A point cloud map is a map constituted of a point cloud (point group data). A vector map is a map in which information such as positions of lanes and traffic lights are associated with a point cloud map. For example, the point cloud map and the vector map may be provided by an external server or the like or created by the vehicle 1 as a map to be matched with a local map (to be described later) based on sensing results by a radar 52, LiDAR 53, or the like and accumulated in the map information accumulating portion 23. In addition, when a high-precision map is to be provided by an external server or the like, in order to reduce communication capacity, map data of, for example, a square with several hundred meters per side regarding a planned path to be traveled by the vehicle 1 is acquired from the server or the like.

The GNSS receiving portion 24 receives a GNSS signal from a GNSS satellite and supplies the travel support/ automated driving control portion 29 with the GNSS signal.

The external recognition sensor 25 includes various sensors used to recognize external circumstances of the vehicle 1 and supplies each portion of the vehicle control system 11 with sensor data from each sensor. The external recognition sensor 25 may include any type of or any number of sensors.

For example, the external recognition sensor 25 includes a camera 51, the radar 52, the LiDAR (Light Detection and Ranging or Laser Imaging Detection and Ranging) 53, and an ultrasonic sensor 54. The numbers of the camera 51, the radar 52, the LiDAR 53, and the ultrasonic sensor 54 are arbitrary and an example of a sensing area of each sensor will be described later.

As the camera 51, for example, a camera adopting any photographic method such as a ToF (Time of Flight) camera, a stereo camera, a monocular camera, or an infrared camera is used as necessary.

In addition, for example, the external recognition sensor 25 includes an environmental sensor for detecting weather, meteorological phenomena, brightness, and the like. For example, the environmental sensor includes a raindrop sensor, a fog sensor, a sunshine sensor, a snow sensor, an illuminance sensor, or the like.

Furthermore, for example, the external recognition sensor 25 includes a microphone to be used to detect sound around the vehicle 1, a position of a sound source, or the like.

The in-vehicle sensor 26 includes various sensors for detecting information inside the vehicle and supplies each portion of the vehicle control system 11 with sensor data from each sensor. The in-vehicle sensor 26 may include any type of or any number of sensors.

For example, the in-vehicle sensor 26 includes a camera, a radar, a seat sensor, a steering wheel sensor, a microphone, or a biometric sensor. As the camera, for example, a camera adopting any photographic method such as a ToF camera, a stereo camera, a monocular camera, or an infrared camera can be used. For example, the biometric sensor is provided on a seat, the steering wheel, or the like and detects various kinds of biological information of an occupant such as a driver.

The vehicle sensor 27 includes various sensors for detecting a state of the vehicle 1 and supplies each portion of the vehicle control system 11 with sensor data from each sensor. The vehicle sensor 27 may include any type of or any number of sensors.

For example, the vehicle sensor 27 includes a velocity sensor, an acceleration sensor, an angular velocity sensor (gyroscope sensor), and an inertial measurement unit (IMU). For example, the vehicle sensor 27 includes a steering angle sensor which detects a steering angle of a steering wheel, a yaw rate sensor, an accelerator sensor which detects an operation amount of an accelerator pedal, and a brake sensor which detects an operation amount of a brake pedal. For example, the vehicle sensor 27 includes a rotation sensor which detects a rotational speed of an engine or a motor, an air pressure sensor which detects air pressure of a tire, a slip ratio sensor which detects a slip ratio of a tire, and a wheel speed sensor which detects a rotational speed of a wheel. For example, the vehicle sensor 27 includes a battery sensor which detects remaining battery life and temperature of a battery and an impact sensor which detects an impact from the outside.

For example, the recording portion 28 includes a ROM (Read Only Memory), a RAM (Random Access Memory), a magnetic storage device such as an HDD (Hard Disc Drive), a semiconductor storage device, an optical storage device, and an magnetooptical storage device. The recording portion 28 records various kinds of programs, data, and the like used by each portion of the vehicle control system 11. For example, the recording portion 28 records a rosbag file including messages transmitted and received by a ROS (Robot Operating System) on which an application program related to automated driving runs. For example, the recording portion 28 includes an EDR (Event Data Recorder) or a DSSAD (Data Storage System for Automated Driving) and records information on the vehicle 1 before and after an event such as an accident.

The travel support/ automated driving control portion 29 controls travel support and automated driving of the vehicle 1. For example, the travel support/ automated driving control portion 29 includes an analyzing portion 61, an action planning portion 62, and an operation control portion 63.

The analyzing portion 61 performs analysis processing of the vehicle 1 and its surroundings. The analyzing portion 61 includes a self-position estimating portion 71, a sensor fusion portion 72, and the recognizing portion 73.

The self-position estimating portion 71 estimates a self-position of the vehicle 1 based on sensor data from the external recognition sensor 25 and the high-precision map accumulated in the map information accumulating portion 23. For example, the self-position estimating portion 71 estimates a self-position of the vehicle 1 by generating a local map based on sensor data from the external recognition sensor 25 and matching the local map and the high-precision map with each other. A position of the vehicle 1 is based on, for example, a center of the rear axle.

The local map is, for example, a three-dimensional high-precision map, an occupancy grid map, or the like created using a technique such as SLAM (Simultaneous Localization and Mapping). An example of a three-dimensional high-precision map is the point cloud map described above. An occupancy grid map is a map which is created by dividing a three-dimensional or two-dimensional space around the vehicle 1 into grids of a predetermined size and which indicates an occupancy of an object in grid units. The occupancy of an object is represented by, for example, a presence or an absence of the object or an existence probability of the object. The local map is also used in, for example, detection processing and recognition processing of external circumstances of the vehicle 1 by the recognizing portion 73.

It should be noted that the self-position estimating portion 71 may estimate a self-position of the vehicle 1 based on an GNSS signal and sensor data from the vehicle sensor 27.

The sensor fusion portion 72 performs sensor fusion processing for obtaining new information by combining sensor data of a plurality of different types (for example, image data supplied from the camera 51 and sensor data supplied from the radar 52). Methods of combining sensor data of different types include integration, fusion, and association.

The recognizing portion 73 performs detection processing and recognition processing of external circumstances of the vehicle 1.

For example, the recognizing portion 73 performs detection processing and recognition processing of external circumstances of the vehicle 1 based on information from the external recognition sensor 25, information from the self-position estimating portion 71, information from the sensor fusion portion 72, and the like.

Specifically, for example, the recognizing portion 73 performs detection processing, recognition processing, and the like of an object in the periphery of the vehicle 1. The detection processing of an object refers to, for example, processing for detecting a presence or an absence, a size, a shape, a position, a motion, or the like of an object. The recognition processing of an object refers to, for example, processing for recognizing an attribute such as a type of an object or identifying a specific object. However, a distinction between detection processing and recognition processing is not always obvious and an overlap may sometimes occur.

For example, the recognizing portion 73 detects an object in the periphery of the vehicle 1 by performing clustering in which a point cloud based on sensor data of LiDAR, a radar, or the like is classified into blocks of point groups. Accordingly, a presence or an absence, a size, a shape, and a position of an object in the periphery of the vehicle 1 are detected.

For example, the recognizing portion 73 detects a motion of an object in the periphery of the vehicle 1 by performing tracking so as to track a motion of a block of point groups having been classified by clustering. Accordingly, a speed and a travel direction (motion vector) of the object in the periphery of the vehicle 1 are detected.

For example, the recognizing portion 73 recognizes a type of an object in the periphery of the vehicle 1 by performing object recognition processing such as semantic segmentation with respect to image data supplied from the camera 51.

As an object to be a detection or recognition target, for example, a vehicle, a person, a bicycle, an obstacle, a structure, a road, a traffic light, a traffic sign, or a road sign is assumed.

For example, the recognizing portion 73 performs recognition processing of traffic rules in the periphery of the vehicle 1 based on maps accumulated in the map information accumulating portion 23, an estimation result of a self-position, and a recognition result of an object in the periphery of the vehicle 1. Due to the processing, for example, a position and a state of traffic lights, contents of traffic signs and road signs, contents of road traffic regulations, and travelable lanes are recognized.

For example, the recognizing portion 73 performs recognition processing of a surrounding environment of the vehicle 1. As a surrounding environment to be a recognition target, for example, weather, air temperature, humidity, brightness, and road surface conditions are assumed.

The action planning portion 62 creates an action plan of the vehicle 1. For example, the action planning portion 62 creates an action plan by performing processing of path planning and path following.

Path planning (Global path planning) is processing of planning a general path from start to goal. Path planning also includes processing of trajectory generation (local path planning) which is referred to as trajectory planning and which enables safe and smooth travel in the vicinity of the vehicle 1 in consideration of motion characteristics of the vehicle 1 along a path planned by path planning.

Path following refers to processing of planning an operation for safely and accurately traveling the path planned by path planning within a planned time. For example, a target velocity and a target angular velocity of the vehicle 1 are calculated.

The operation control portion 63 controls operations of the vehicle 1 in order to realize the action plan created by the action planning portion 62.

For example, the operation control portion 63 controls a steering control portion 81, a brake control portion 82, and a drive control portion 83 to perform acceleration/deceleration control and directional control so that the vehicle 1 travels along a trajectory calculated by trajectory planning. For example, the operation control portion 63 performs cooperative control in order to realize functions of ADAS such as collision avoidance or shock mitigation, car-following driving, constant-speed driving, collision warning of own vehicle, and lane deviation warning of own vehicle. For example, the operation control portion 63 performs cooperative control in order to realize automated driving or the like in which a vehicle autonomously travels irrespective of manipulations by a driver.

The DMS 30 performs authentication processing of a driver, recognition processing of a state of the driver, and the like based on sensor data from the in-vehicle sensor 26, input data that is input to the HMI 31, and the like. As a state of the driver to be a recognition target, for example, a physical condition, a level of arousal, a level of concentration, a level of fatigue, an eye gaze direction, a level of intoxication, a driving operation, or a posture is assumed.

Alternatively, the DMS 30 may be configured to perform authentication processing of an occupant other than the driver and recognition processing of a state of the occupant. In addition, for example, the DMS 30 may be configured to perform recognition processing of a situation inside the vehicle based on sensor data from the in-vehicle sensor 26. As the situation inside the vehicle to be a recognition target, for example, air temperature, humidity, brightness, or odor is assumed.

The HMI 31 is used to input various kinds of data and instructions, generates an input signal based on input data, an input instruction, or the like, and supplies each portion of the vehicle control system 11 with the generated input signal. For example, the HMI 31 includes an operation device such as a touch panel, a button, a microphone, a switch, or a lever, an operation device which accepts input by methods other than manual operations such as voice or gestures, and the like. For example, the HMI 31 may be a remote-controlled apparatus which utilizes infrared light or other radio waves, a mobile device which accommodates operations of the vehicle control system 11, an externally-connected device such as a wearable device, or the like.

In addition, the HMI 31 performs generation and output of visual information, audio information, and tactile information with respect to an occupant or the outside of the vehicle and performs output control for controlling output contents, output timings, output methods, and the like. For example, visual information is information represented by images and light such as a monitor image indicating an operating screen, a state display of the vehicle 1, a warning display, or surroundings of the vehicle 1. For example, audio information is information represented by sound such as a guidance, a warning sound, or a warning message. For example, tactile information is information that is tactually presented to an occupant by a force, a vibration, a motion, or the like.

As a device for outputting visual information, for example, a display apparatus, a projector, a navigation apparatus, an instrument panel, a CMS (Camera Monitoring System), an electronic mirror, or a lamp is assumed. In addition to being an apparatus having an ordinary display, the display apparatus may be an apparatus for displaying visual information in a field of view of an occupant such as a head-up display, a light-transmitting display, or a wearable device equipped with an AR (Augmented Reality) function.

As a device for outputting audio information, for example, an audio speaker, headphones, or earphones is assumed.

As a device for outputting tactile information, for example, a haptic element or the like using a haptic technique is assumed. For example, the haptic element is provided inside a steering wheel, a seat, or the like.

The vehicle control portion 32 controls each portion of the vehicle 1. The vehicle control portion 32 includes the steering control portion 81, the brake control portion 82, the drive control portion 83, a body system control portion 84, a light control portion 85, and a horn control portion 86.

The steering control portion 81 performs detection, control, and the like of a state of a steering system of the vehicle 1. The steering system includes, for example, a steering mechanism including a steering wheel and the like, electronic power steering, and the like. For example, the steering control portion 81 includes a control unit such as an ECU which controls the steering system, an actuator which drives the steering system, and the like.

The brake control portion 82 performs detection, control, and the like of a state of a brake system of the vehicle 1. For example, the brake system includes a brake mechanism including a brake pedal and the like, an ABS (Antilock Brake System), and the like. For example, the brake control portion 82 includes a control unit such as an ECU which controls the brake system, an actuator which drives the brake system, and the like.

The drive control portion 83 performs detection, control, and the like of a state of a drive system of the vehicle 1. For example, the drive system includes an accelerator pedal, a drive force generating apparatus for generating a drive force such as an internal-combustion engine or a drive motor, a drive force transmission mechanism for transmitting the drive force to the wheels, and the like. For example, the drive control portion 83 includes a control unit such as an ECU which controls the drive system, an actuator which drives the drive system, and the like.

The body system control portion 84 performs detection, control, and the like of a state of a body system of the vehicle 1. For example, the body system includes a keyless entry system, a smart key system, a power window apparatus, a power seat, an air conditioner, an airbag, a seatbelt, and a shift lever. For example, the body system control portion 84 includes a control unit such as an ECU which controls the body system, an actuator which drives the body system, and the like.

The light control portion 85 performs detection, control, and the like of a state of various lights of the vehicle 1. As lights to be a control target, for example, a headlamp, a tail lamp, a fog lamp, a turn signal, a brake lamp, a projector lamp, and a bumper display are assumed. The light control portion 85 includes a control unit such as an ECU which controls the lights, an actuator which drives the lights, and the like.

The horn control portion 86 performs detection, control, and the like of a state of a car horn of the vehicle 1. For example, the horn control portion 86 includes a control unit such as an ECU which controls the car horn, an actuator which drives the car horn, and the like.

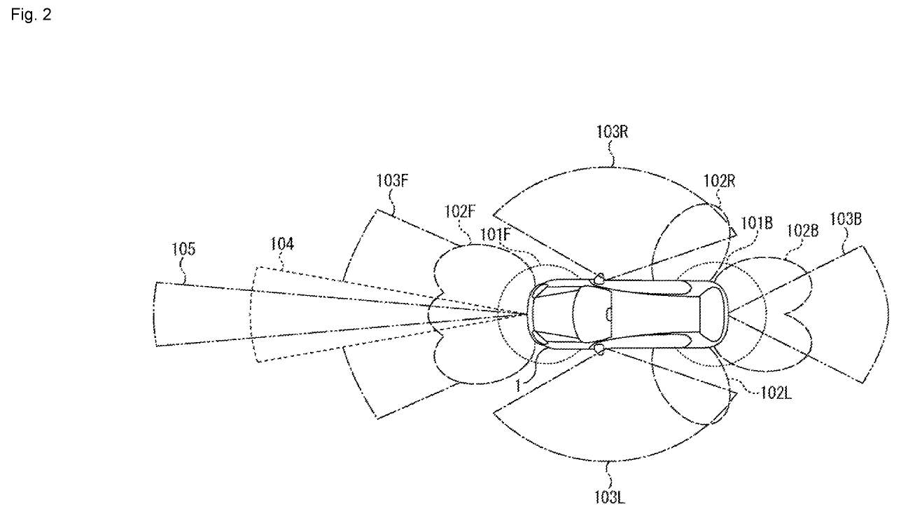

FIG. 2 is a diagram showing an example of sensing areas by the camera 51, the radar 52, the LiDAR 53, and the ultrasonic sensor 54 of the external recognition sensor 25 shown in FIG. 1.

A sensing area 101F and a sensing area 101B represent an example of sensing areas of the ultrasonic sensor 54. The sensing area 101F covers a periphery of a front end of the vehicle 1. The sensing area 101B covers a periphery of a rear end of the vehicle 1.

Sensing results in the sensing area 101F and the sensing area 101B are used to provide the vehicle 1 with parking assistance or the like.

A sensing area 102F to a sensing area 102B represent an example of sensing areas of the radar 52 for short or intermediate distances. The sensing area 102F covers up to a position farther than the sensing area 101F in front of the vehicle 1. The sensing area 102B covers up to a position farther than the sensing area 101B to the rear of the vehicle 1. The sensing area 102L covers a periphery toward the rear of a left-side surface of the vehicle 1. The sensing area 102R covers a periphery toward the rear of a right-side surface of the vehicle 1.

A sensing result in the sensing area 102F is used to detect, for example, a vehicle, a pedestrian, or the like present in front of the vehicle 1. A sensing result in the sensing area 102B is used by, for example, a function of preventing a collision to the rear of the vehicle 1. Sensing results in the sensing area 102L and the sensing area 102R are used to detect, for example, an object present in blind spots to the sides of the vehicle 1.

A sensing area 103F to a sensing area 103B represent an example of sensing areas by the camera 51. The sensing area 103F covers up to a position farther than the sensing area 102F in front of the vehicle 1. The sensing area 103B covers up to a position farther than the sensing area 102B to the rear of the vehicle 1. The sensing area 103L covers a periphery of the left-side surface of the vehicle 1. The sensing area 103R covers a periphery of the right-side surface of the vehicle 1.

For example, a sensing result in the sensing area 103F is used to recognize a traffic light or a traffic sign, used by a lane deviation prevention support system, and the like. A sensing result in the sensing area 103B is used for parking assistance, used in a surround view system, and the like. Sensing results in the sensing area 103L and the sensing area 103R are used in, for example, a surround view system.

A sensing area 104 represents an example of a sensing area of the LiDAR 53. The sensing area 104 covers up to a position farther than the sensing area 103F in front of the vehicle 1. On the other hand, the sensing area 104 has a narrower range in a left-right direction than the sensing area 103F.

A sensing result in the sensing area 104 is used for, for example, emergency braking, collision avoidance, and pedestrian detection.

A sensing area 105 represents an example of a sensing area of the radar 52 for long distances. The sensing area 105 covers up to a position farther than the sensing area 104 in front of the vehicle 1. On the other hand, the sensing area 105 has a narrower range in the left-right direction than the sensing area 104.

A sensing result in the sensing area 105 is used for, for example, ACC (Adaptive Cruise Control).

It should be noted that the sensing area of each sensor may adopt various configurations other than those shown in FIG. 2. Specifically, the ultrasonic sensor 54 may be configured to also sense the sides of the vehicle 1 or the LiDAR 53 may be configured to also sense the rear of the vehicle 1.

### 2. First Embodiment

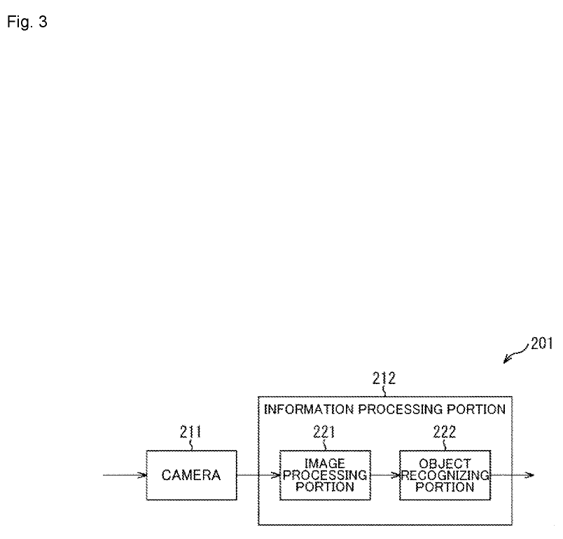

Referring to FIGS. 3 to 8, a first embodiment of the present technique will be described below.

### Configuration Example of Information Processing System 201

FIG. 3 shows a configuration example of an information processing system 201 being a first embodiment of the information processing system to which the present technique is applied.

For example, the information processing system 201 is mounted to the vehicle 1 and performs object recognition of a periphery of the vehicle 1.

The information processing system 201 includes a camera 211 and an information processing portion 212.

The camera 211 constitutes, for example, a part of the camera 51 shown in FIG. 1, photographs the front of the vehicle 1, and supplies the information processing portion 212 with an obtained image (hereinafter, referred to as a photographed image).

The information processing portion 212 includes an image processing portion 221 and an object recognizing portion 222.

The image processing portion 221 performs predetermined image processing on a photographed image. For example, the image processing portion 221 performs thinning processing, filtering processing, or the like of pixels of the photographed image in accordance with a size of an image that can be processed by the object recognizing portion 222 and reduces the number of pixels of the photographed image. The image processing portion 221 supplies the object recognizing portion 222 with the photographed image after the image processing.

The object recognizing portion 222 constitutes, for example, a part of the recognizing portion 73 shown in FIG. 1, performs object recognition in the front of the vehicle 1 using a CNN, and outputs data representing a recognition result. The object recognizing portion 222 is generated by performing machine learning in advance.

### First Embodiment of Object Recognizing Portion 222

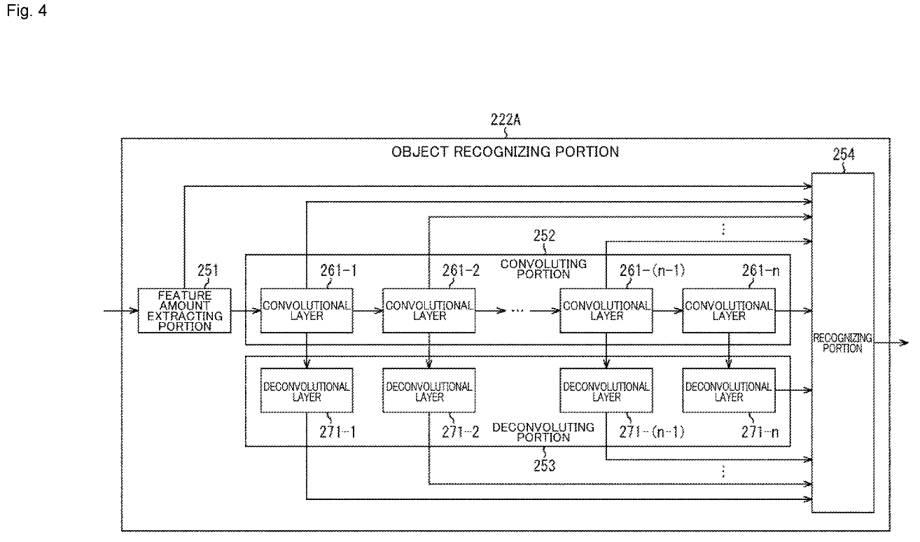

FIG. 4 shows a configuration example of an object recognizing portion 222A being a first embodiment of the object recognizing portion 222 shown in FIG. 3.

The object recognizing portion 222A includes a feature amount extracting portion 251, a convoluting portion 252, a deconvoluting portion 253, and a recognizing portion 254.

The feature amount extracting portion 251 is constituted of, for example, a feature amount extraction model such as VGG-16. The feature amount extracting portion 251 extracts a feature amount of a photographed image and generates a feature map (hereinafter, referred to as a photographed image feature map) which represents a distribution of feature amounts in two dimensions. The feature amount extracting portion 251 supplies the convoluting portion 252 and the recognizing portion 254 with the photographed image feature map.

The convoluting portion 252 includes n-number of convolutional layers 261-1 to 261-n.

Hereinafter, when there is no need to individually distinguish the convolutional layers 261-1 to 261-n from each other, the convolutional layers will be simply referred to as a convolutional layer 261. In addition, hereinafter, the convolutional layer 261-1 is assumed to be an uppermost (shallowest) convolutional layer 261 and the convolutional layer 261-n is assumed to be a lowermost (deepest) convolutional layer 261.

The deconvoluting portion 253 includes the same n-number as the convoluting portion 252 of deconvolutional layers 271-1 to 271-n.

Hereinafter, when there is no need to individually distinguish the deconvolutional layers 271-1 to 271-n from each other, the deconvolutional layers will be simply referred to as a deconvolutional layer 271. In addition, hereinafter, the deconvolutional layer 271-1 is assumed to be an uppermost (shallowest) deconvolutional layer 271 and the deconvolutional layer 271-n is assumed to be a lowermost (deepest) deconvolutional layer 271. Furthermore, hereinafter, combinations of the convolutional layer 261-1 and the deconvolutional layer 271-1, the convolutional layer 261-2 and the deconvolutional layer 271-2, ..., and the convolutional layer 261-n and the deconvolutional layer 271-n are respectively assumed to be combinations of the convolutional layer 261 and the deconvolutional layer 271 of a same layer.

The convolutional layer 261-1 performs convolution of a photographed image feature map and generates a feature map (hereinafter, referred to as a convolutional feature map) of a next layer below (next deeper layer). The convolutional layer 261-1 supplies the convolutional layer 261-2 of the next layer below, the deconvolutional layer 271-1 of the same layer, and the recognizing portion 254 with the generated convolutional feature map.

The convolutional layer 261-2 performs convolution of the convolutional feature map generated by the convolutional layer 261-1 of a next layer above and generates a convolutional feature map of a next layer below. The convolutional layer 261-2 supplies the convolutional layer 261-3 of the next layer below, the deconvolutional layer 271-2 of the same layer, and the recognizing portion 254 with the generated convolutional feature map.

Each convolutional layer 261 from the convolutional layer 261-3 and thereafter performs processing similar to the convolutional layer 261-2. In other words, each convolutional layer 261 performs convolution of the convolutional feature map generated by the convolutional layer 261 of a next layer above and generates a convolutional feature map of a next layer below. Each convolutional layer 261 supplies the convolutional layer 261 of a next layer below, the deconvolutional layer 271 of the same layer, and the recognizing portion 254 with the generated convolutional feature map. Since the lowermost convolutional layer 261-n does not have a convolutional layer 261 of a lower layer, the convolutional layer 261-n does not supply a convolutional layer 261 of a next layer below with a convolutional feature map.

Note that the number of convolutional feature maps generated by each convolutional layer 261 is arbitrary and a plurality of feature maps may be generated.

Each deconvolutional layer 271 performs deconvolution of the convolutional feature map supplied from the convolutional layer 261 of the same layer and generates a feature map (hereinafter, referred to as a deconvolutional feature map) of a next layer above (next shallower layer). Each deconvolutional layer 271 supplies the recognizing portion 254 with the generated deconvolutional feature map.

The recognizing portion 254 performs object recognition of the front of the vehicle 1 based on the photographed image feature map supplied from the feature amount extracting portion 251, the convolutional feature map supplied from each convolutional layer 261, and the deconvolutional feature map supplied from each deconvolutional layer 271.

### Object Recognition Processing

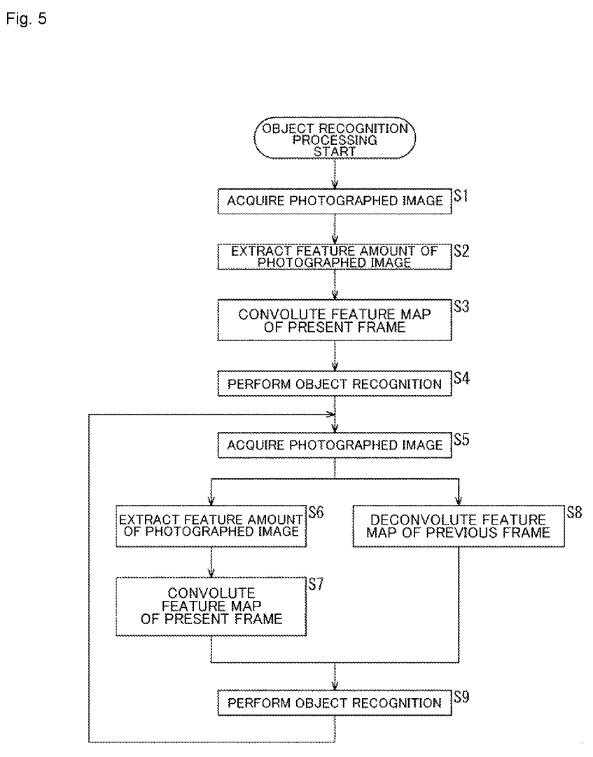

Next, object recognition processing to be executed by the information processing system 201 will be described with reference to a flowchart shown in FIG. 5.

For example, the processing is started when the vehicle 1 is started and an operation to start driving is performed such as when an ignition switch, a power switch, a start switch, or the like of the vehicle 1 is turned on. In addition, for example, the processing is ended when an operation to end driving of the vehicle 1 is performed such as when the ignition switch, the power switch, the start switch, or the like of the vehicle 1 is turned off.

In step S1, the information processing system 201 acquires a photographed image. Specifically, the camera 211 photographs the front of the vehicle 1 and supplies the image processing portion 221 with an obtained photographed image.

In step S2, the information processing portion 212 extracts a feature amount of the photographed image.

Specifically, the image processing portion 221 performs predetermined image processing on the photographed image and supplies the feature amount extracting portion 251 with the photographed image after the image processing.

The feature amount extracting portion 251 extracts a feature amount of the photographed image and generates a photographed image feature map. The feature amount extracting portion 251 supplies the convolutional layer 261-1 and the recognizing portion 254 with the photographed image feature map.

In step S3, the convoluting portion 252 performs convolution of a feature map of the present frame.

Specifically, the convolutional layer 261-1 performs convolution of the photographed image feature map of the present frame supplied from the feature amount extracting portion 251 and generates a convolutional feature map of a next layer below. The convolutional layer 261-1 supplies the convolutional layer 261-2 of the next layer below, the deconvolutional layer 271-1 of the same layer, and the recognizing portion 254 with the generated convolutional feature map.

The convolutional layer 261-2 performs convolution of the convolutional feature map supplied from the convolutional layer 261-2 and generates a convolutional feature map of a next layer below. The convolutional layer 261-2 supplies the convolutional layer 261-3 of the next layer below, the deconvolutional layer 271-2 of the same layer, and the recognizing portion 254 with the generated convolutional feature map.

Each convolutional layer 261 from the convolutional layer 261-3 and thereafter performs processing similar to the convolutional layer 261-2. In other words, each convolutional layer 261 performs convolution of a convolutional feature map supplied from the convolutional layer 261 of a next layer above and generates a convolutional feature map of a next layer below. In addition, each convolutional layer 261 supplies the convolutional layer 261 of the next layer below, the deconvolutional layer 271 of the same layer, and the recognizing portion 254 with the generated convolutional feature map. Since the lowermost convolutional layer 261-n does not have a convolutional layer 261 of a lower layer, the convolutional layer 261-n does not supply a convolutional layer 261 of a next layer below with a convolutional feature map.

The convolutional feature map of each convolutional layer 261 has a smaller number of pixels and contains more feature amounts based on a wider field of view as compared to a feature map of a next layer above prior to convolution (a photographed image feature map or a convolutional feature map of the convolutional layer 261 of the next layer above). Therefore, the convolutional feature map of each convolutional layer 261 is suitable for recognition of an object with a larger size as compared to a feature map of a next layer above.

In step S4, the recognizing portion 254 performs object recognition. Specifically, the recognizing portion 254 performs object recognition of the front of the vehicle 1 respectively using a photographed image feature map and a convolutional feature map supplied from each convolutional layer 261. The recognizing portion 254 outputs data representing a result of object recognition to a subsequent stage.

In step S5, a photographed image is acquired in a similar manner to the processing of step S1. In other words, a photographed image of a next frame is acquired.

In step S6, a feature amount of the photographed image is acquired in a similar manner to the processing of step S2.

In step S7, convolution of a feature map of the present frame is performed in a similar manner to the processing of step S3.

Thereafter, the processing proceeds to step S9.

On the other hand, in step S8, the deconvoluting portion 253 performs deconvolution of a feature map of a previous frame in parallel to processing of steps S6 and S7.

Specifically, the deconvolutional layer 271-1 performs deconvolution of a convolutional feature map of a last frame generated by the convolutional layer 261-1 of the same layer and generates a deconvolutional feature map. The deconvolutional layer 271-1 supplies the recognizing portion 254 with the generated deconvolutional feature map.

The deconvolutional feature map of the deconvolutional layer 271-1 is a feature map of a same layer as the photographed image feature map and has a same number of pixels. In addition, feature amounts of the deconvolutional feature map of the deconvolutional layer 271-1 are more sophisticated than those of the photographed image feature map of the same layer. For example, in addition to feature amounts of a field of view equivalent to that of the photographed image feature map, the deconvolutional feature map of the deconvolutional layer 271-1 contains more feature amounts with a wider field of view than the photographed image feature map which are contained in the convolutional feature map of a next layer below prior to the deconvolution (the convolutional feature map of the convolutional layer 261-1).

The deconvolutional layer 271-2 performs deconvolution of the convolutional feature map of a last frame generated by the convolutional layer 261-2 of the same layer and generates a deconvolutional feature map. The deconvolutional layer 271-2 supplies the recognizing portion 254 with the generated deconvolutional feature map.

The deconvolutional feature map of the deconvolutional layer 271-2 is a feature map of a same layer as the convolutional feature map of the convolutional layer 261-1 and has a same number of pixels. In addition, feature amounts of the deconvolutional feature map of the deconvolutional layer 271-2 are more sophisticated that those of the convolutional feature map of the same layer (the convolutional feature map of the convolutional layer 261-1). For example, in addition to feature amounts of a field of view equivalent to that of the convolutional feature map of the same layer, the deconvolutional feature map of the deconvolutional layer 271-2 contains more feature amounts with a wider field of view than the convolutional feature map of the same layer which are contained in the convolutional feature map of a next layer below prior to the deconvolution (the convolutional feature map of the convolutional layer 261-2).

Each deconvolutional layer 271 from the deconvolutional layer 271-3 and thereafter performs processing similar to the deconvolutional layer 271-2. In other words, each deconvolutional layer 271 performs deconvolution of a convolutional feature map of a last frame generated by the convolutional layer 261 of the same layer and generates a deconvolutional feature map. In addition, each deconvolutional layer 271 supplies the recognizing portion 254 with the generated deconvolutional feature map.

The deconvolutional feature map of each deconvolutional layer 271 from the deconvolutional layer 271-3 and thereafter is a feature map of a same layer as the convolutional feature map of the convolutional layer 261 of a next layer above and has the same number of pixels. In addition, feature amounts of the deconvolutional feature map of each deconvolutional layer 271 are more sophisticated than the convolutional feature map of the same layer. For example, in addition to feature amounts of a field of view equivalent to that of the convolutional feature map of the same layer, the deconvolutional feature map of each deconvolutional layer 271 contains more feature amounts with a wider field of view than the convolutional feature map of the same layer which are contained in the convolutional feature map of a next layer below prior to the deconvolution.

Thereafter, the processing proceeds to step S9.

In step S9, the recognizing portion 254 performs object recognition. Specifically, the recognizing portion 254 performs object recognition based on the photographed image feature map of the present frame, the convolutional feature map of the present frame, and the deconvolutional feature map of a last frame. In this case, the recognizing portion 254 performs object recognition by combining the photographed image feature map or the convolutional feature map with the deconvolutional feature map of the same layer.

Subsequently, the processing returns to step S5 and the processing of steps S5 to S9 are repeatedly executed.

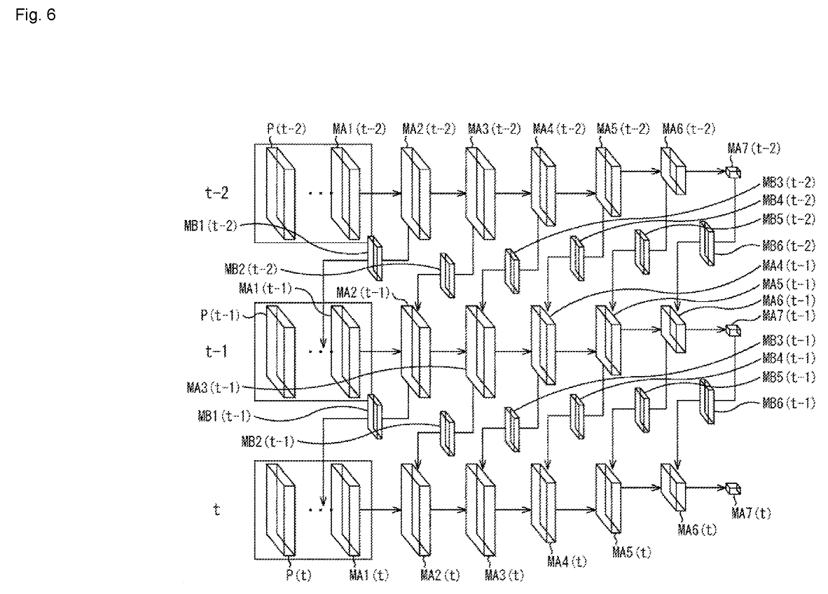

A specific example of the processing of steps S5 to S9 in FIG. 5 will now be described with reference to FIG. 6.

Note that FIG. 6 shows an example of a case where the convoluting portion 252 includes six convolutional layers 261 and the deconvoluting portion 253 includes six deconvolutional layers 271.

First, let us assume that at time of day t-2, a photographed image P(t-2) has been acquired and feature maps MA1(t-2) to MA7(t-2) have been generated based on the photographed image P(t-2). The feature map MA1(t-2) is a photographed image feature map generated by extracting a feature amount of the photographed image P(t-2). The feature maps MA2(t-2) to MA7(t-2) are convolutional feature maps of a plurality of layers which are generated in each convolution when performing convolution of the feature map MA1(t-2) six times.

Hereinafter, when there is no need to individually distinguish the feature maps MA1(t-2) to MA7(t-2) from each other, the feature maps will be simply referred to as a feature map MA(t-2). This similarly applies to feature maps MA of other times of day.

At time of day t-1, in a similar manner to processing at time of day t-2, a photographed image P(t-1) is acquired and feature maps MA1(t-1) to MA7(t-1) are generated based on the photographed image P(t-1). In addition, deconvolution of feature maps MA2(t-2) to MA7(t-2) of a last frame is performed and feature maps MB1(t-2) to MB6(t-2) being deconvolutional feature maps are generated.

Hereinafter, when there is no need to individually distinguish the feature maps MB1(t-2) to MB6(t-2) from each other, the feature maps will be simply referred to as a feature map MB(t-2). This similarly applies to feature maps MB of other times of day.

In addition, object recognition is performed based on the feature map MA(t-1) based on the photographed image P(t-1) of the present frame and the feature map MB(t-2) based on the photographed image P(t-2) of the last frame.

At this point, object recognition is performed by combining the feature map MA(t-1) and the feature map MB(t-2) of a same layer.

For example, object recognition is individually performed based on a feature map MA1(t-1) and a feature map MB1(t-2) of the same layer. In addition, a recognition result of an object based on the feature map MA1(t-1) and a recognition result of an object based on the feature map MB1(t-2) are integrated. For example, an object recognized based on the feature map MA1(t-1) and an object recognized based on the feature map MB1(t-2) are selected (or not selected) based on reliability or the like.

Object recognition is individually performed and recognition results are integrated in a similar manner with respect to combinations of the feature map MA(t-1) and the feature map MB(t-2) of other same layers. Note that, with respect to the feature map MA7(t-1), object recognition is performed independently since the feature map MB(t-2) of the same layer is not present.

In addition, recognition results of objects based on feature maps of each layer are integrated and data representing an integrated recognition result is output to a subsequent stage.

Alternatively, for example, the feature map MA1(t-1) and the feature map MB1(t-2) of the same layer are synthesized by addition, multiplication, or the like. Furthermore, object recognition is performed based on the synthesized feature map.

The feature map MA1(t-1) and the feature map MB1(t-2) are synthesized in a similar manner with respect to combinations of the feature map MA(t-1) and the feature map MB(t-2) of other same layers and object recognition is performed based on the synthesized feature map. Note that, with respect to the feature map MA7(t-1), object recognition is performed independently since the feature map MB(t-2) of the same layer is not present.

In addition, recognition results of objects based on feature maps of each layer are integrated and data representing an integrated recognition result is output to a subsequent stage.

Even at time of day t, processing similar to that performed at time of day t-1 is performed. Specifically, a photographed image P(t) is acquired and feature maps MA1(t) to MA7(t) are generated based on the photographed image P(t). In addition, deconvolution of feature maps MA2(t-1) to MA7(t-1) of the last frame is performed and feature maps MB1(t-1) to MB6(t-1) are generated.

Subsequently, object recognition is performed based on the feature map MA(t-1) based on the photographed image P(t) of the present frame and the feature map MB1(t-1) based on the photographed image P(t-1) of the last frame. At this point, object recognition is performed by combining the feature map MA(t) and the feature map MB(t-1) of a same layer.

As described above, in object recognition using a CNN, recognition accuracy can be improved while suppressing an increase in load.

Specifically, object recognition is performed by also using a deconvolutional feature map based on a photographed image of a last frame in addition to a photographed image feature map and a convolutional feature map based on a photographed image of a present frame. Accordingly, a sophisticated feature amount of a deconvolutional feature map is to be used in object recognition and recognition accuracy improves.

On the other hand, for example, in the invention disclosed in PTL 1 described above, although object recognition is performed based on a feature map that combines convolutional feature maps of a same layer of a last frame and a present frame, a deconvolutional feature map containing a sophisticated feature amount is not used.

In addition, for example, recognition accuracy of an object which has been clearly visible in a photographed image of a last frame but is no longer clearly visible in a photographed image of the present frame due to a flicker, due to being hidden by another object, or the like improves.

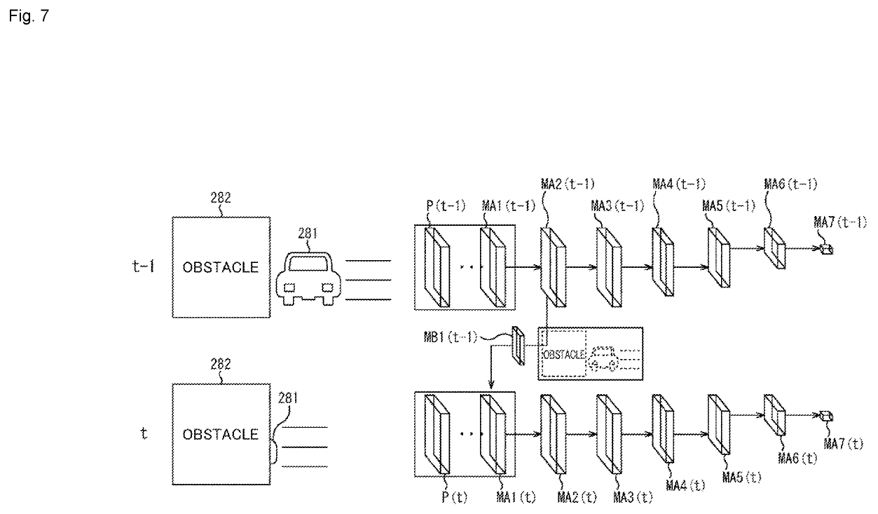

For example, in the example shown in FIG. 7, a vehicle 281 is not hidden by an obstacle 282 in the photographed image at time of day t-1 but a part of the vehicle 281 is hidden by the obstacle 282 in the photographed image at time of day t.

In this case, for example, a feature amount of the vehicle 281 is extracted in a feature map MA2(t-1) in a frame at time of day t-1. Therefore, even in a feature map MB1(t-1) obtained by performing deconvolution of the feature map MA2(t-1), the feature amount of the vehicle 281 is included. As a result, due to the feature map MB1(t-1) being used in object recognition at time of day t, the vehicle 281 can be accurately recognized.

Accordingly, for example, a flicker of an object recognized between frames is suppressed.

Furthermore, using a deconvolutional feature map based on a photographed image of a last frame enables generation processing of a convolutional feature map and generation processing of a deconvolutional feature map to be used in object recognition of a same frame to be executed in parallel.

On the other hand, for example, when using a deconvolutional feature map based on a photographed image of a present frame, generation processing of a deconvolutional feature map cannot be executed until generation of a convolutional feature map is completed.

Therefore, in the information processing system 201, processing time of object recognition can be reduced as compared to a case of using a deconvolutional feature map based on the photographed image of the present frame.

In addition, extraction processing of a feature amount of a photographed image of a last frame need not be performed in each frame as is the case of the invention disclosed in PTL 1 described above. Therefore, a load of processing required for object recognition is reduced.

### 3. Second Embodiment

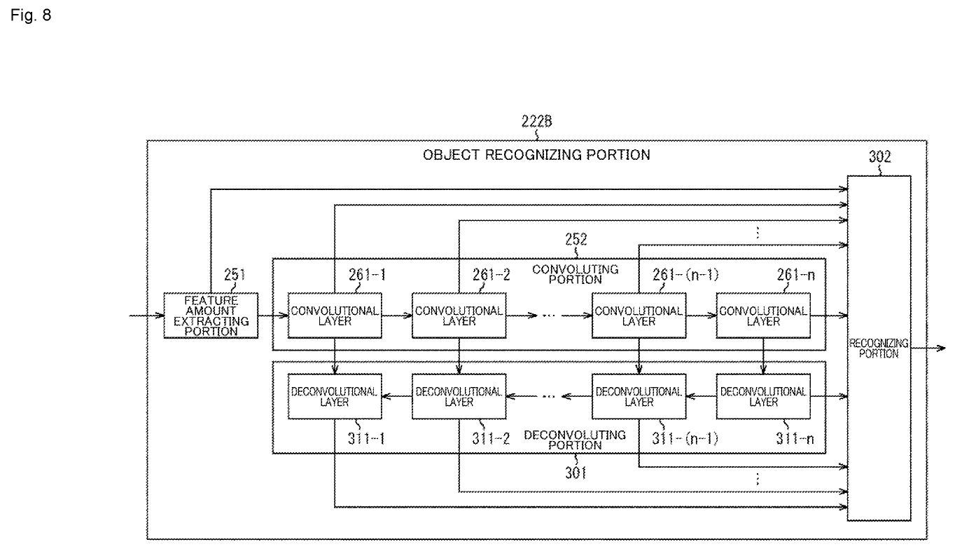

Referring to FIGS. 8 to 10, a second embodiment of the present technique will be described below.

The second embodiment differs from the first embodiment described above in that an object recognizing portion 222B shown in FIG. 8 is used instead of the object recognizing portion 222A shown in FIG. 4 in the object recognizing portion 222 of the information processing system 201 shown in FIG. 3.

### Second Embodiment of Object Recognizing Portion 222B

FIG. 8 shows a configuration example of the object recognizing portion 222B being a second embodiment of the object recognizing portion 222 shown in FIG. 3. In the drawing, same reference signs are given to portions corresponding to the object recognizing portion 222A shown in FIG. 4 and a description thereof will be appropriately omitted.

The object recognizing portion 222B is the same as the object recognizing portion 222A in that the object recognizing portion 222B includes the feature amount extracting portion 251 and the convoluting portion 252. On the other hand, the object recognizing portion 222B differs from the object recognizing portion 222A in that the object recognizing portion 222B includes a deconvoluting portion 301 and a recognizing portion 302 instead of the deconvoluting portion 253 and the recognizing portion 254.

The deconvoluting portion 301 includes n-number of deconvolutional layers 311-1 to 311-n.

When there is no need to individually distinguish the deconvolutional layers 311-1 to 311-n from each other, the deconvolutional layers will be simply referred to as a deconvolutional layer 311. In addition, hereinafter, the deconvolutional layer 311-1 is assumed to be an uppermost deconvolutional layer 311 and the deconvolutional layer 311-n is assumed to be a lowermost deconvolutional layer 311. Furthermore, hereinafter, combinations of the convolutional layer 261-1 and the deconvolutional layer 311-1, the convolutional layer 261-2 and the deconvolutional layer 311-2, •••, and the convolutional layer 261-n and the deconvolutional layer 311-n are respectively assumed to be combinations of the convolutional layer 261 and the deconvolutional layer 311 of a same layer.

Each deconvolutional layer 311 performs deconvolution of the convolutional feature map supplied from the convolutional layer 261 of the same layer in a similar manner to each deconvolutional layer 271 shown in FIG. 4 and generates a deconvolutional feature map. In addition, each deconvolutional layer 311 performs deconvolution of the deconvolutional feature map supplied from the deconvolutional layer 311 of next layer below and generates a deconvolutional feature map of next layer above. Each deconvolutional layer 311 supplies the deconvolutional layer 311 of next layer above and the recognizing portion 302 with the generated deconvolutional feature map. Since the uppermost deconvolutional layer 311-1 does not have a deconvolutional layer 311 of a farther upper layer, the deconvolutional layer 311-1 does not supply a deconvolutional layer 311 of a next layer above with a deconvolutional feature map.

The recognizing portion 302 performs object recognition of the front of the vehicle 1 based on the photographed image feature map supplied from the feature amount extracting portion 251, the convolutional feature map supplied from each convolutional layer 261, and the deconvolutional feature map supplied from each deconvolutional layer 311.

As described above, the object recognizing portion 222B enables deconvolution of a deconvolutional feature map of next layer below to be further executed. Therefore, for example, object recognition can be performed by combining a photographed image feature map or a convolutional feature map with a deconvolutional feature map based on a convolutional feature map of two or more layers below (two or more layers deeper) the photographed image feature map or the convolutional feature map.

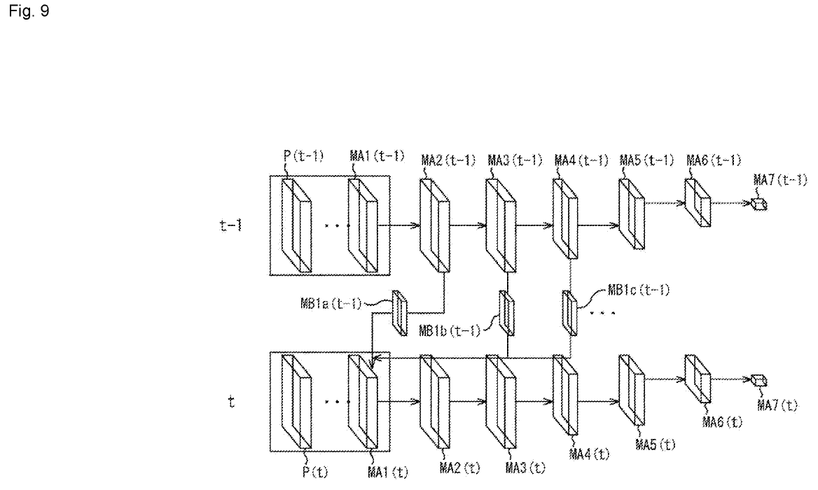

For example, as shown in FIG. 9, object recognition can be performed by combining a photographed image feature map MA1(t) based on a photographed image P(t) of the present frame and a deconvolutional feature map MB1a(t-1), a deconvolutional feature map MB1b(t-1), and a deconvolutional feature map MB1c(t-1) based on a photographed image P(t-1) of the last frame.

Note that the deconvolutional feature map MB1a(t-1) is generated by performing deconvolution of a convolutional feature map MA2(t-1) of a next layer below the photographed image feature map MA1(t) once. The deconvolutional feature map MB1b(t-1) is generated by performing deconvolution of a convolutional feature map MA3(t-1) of two layers below the photographed image feature map MA1(t) twice. The deconvolutional feature map MB1c(t-1) is generated by performing deconvolution of a convolutional feature map MA4(t-1) of three layers below the photographed image feature map MA1(t) three times.

As a result, recognition accuracy of objects can be further improved.

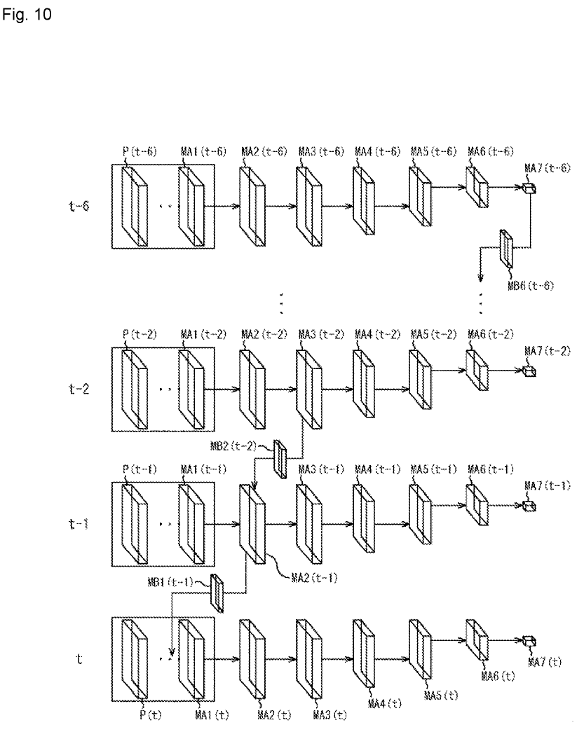

In addition, for example, as shown in FIG. 10, a deconvolutional feature map based on a photographed image of a frame preceding the present by two or more frames can also be used in object recognition.

For example, at time of day t-5, deconvolution of a convolutional feature map MA7(t-6) based on a photographed image P(t-6) is performed and a deconvolutional feature map MB6(t-6) is generated. In addition, at time of day t-5, object recognition is performed based on a combination of feature maps including a convolutional feature map MA6(t-5) (not illustrated) based on a photographed image P(t-5) (not illustrated) and the deconvolutional feature map MB6(t-6).

Next, at time of day t-4, deconvolution of the deconvolutional feature map MB6(t-6) is performed and a deconvolutional feature map MB5(t-5) (not illustrated) is generated. In addition, object recognition is performed based on a combination of feature maps including a convolutional feature map MA5(t-4) (not illustrated) based on a photographed image P(t-4) (not illustrated) and the deconvolutional feature map MB5(t-5).

Next, at time of day t-3, deconvolution of the deconvolutional feature map MB5(t-5) is performed and a deconvolutional feature map MB4(t-4) (not illustrated) is generated. In addition, object recognition is performed based on a combination of feature maps including a convolutional feature map MA4(t-3) (not illustrated) based on a photographed image P(t-3) (not illustrated) and the deconvolutional feature map MB4(t-4).

Next, at time of day t-2, deconvolution of the deconvolutional feature map MB4(t-4) is performed and a deconvolutional feature map MB3(t-3) (not illustrated) is generated. In addition, object recognition is performed based on a combination of feature maps including a convolutional feature map MA3(t-2) (not illustrated) based on a photographed image P(t-2) (not illustrated) and the deconvolutional feature map MB3(t-3).

Next, at time of day t-1, deconvolution of the deconvolutional feature map MB3(t-3) is performed and a deconvolutional feature map MB2(t-2) is generated. In addition, object recognition is performed based on a combination of feature maps including a convolutional feature map MA2(t-1) and the deconvolutional feature map MB2(t-2).

Next, at time of day t, deconvolution of the deconvolutional feature map MB2(t-2) is performed and a deconvolutional feature map MB1(t-1) is generated. In addition, object recognition is performed based on a combination of feature maps including a photographed image feature map MA1(t) and the deconvolutional feature map MB1(t-1).

As described above, with respect to the convolutional feature map MA7(t-6) based on the photographed image P(t-6), in each frame from time of day t-5 to time of day t, reverse tatami-mat likelihood is performed a total of six times until the same layer as the photographed image feature map MA1(t) is reached and the results are used in object recognition.

Moreover, although not illustrated, with respect to the convolutional feature maps MA7(t-5) to MA7(t-1), deconvolution is similarly performed a total of six times until the same layer as the photographed image feature map is reached and the results are used in object recognition.

As described above, in a present frame, object recognition is performed using deconvolutional feature maps based on photographed images from a frame preceding the present by six frames to a last frame. As a result, recognition accuracy of objects can be further improved.

For example, convolutional feature maps other than the convolutional feature map of a lowermost layer (for example, convolutional feature maps MA2(t-6) to MA6(t-6)) may also be subjected to deconvolution per each frame until the same layer as the photographed image feature map is reached and the results may be used in object recognition in a similar manner to the convolutional feature map of the lowermost layer.

### 4. Third Embodiment

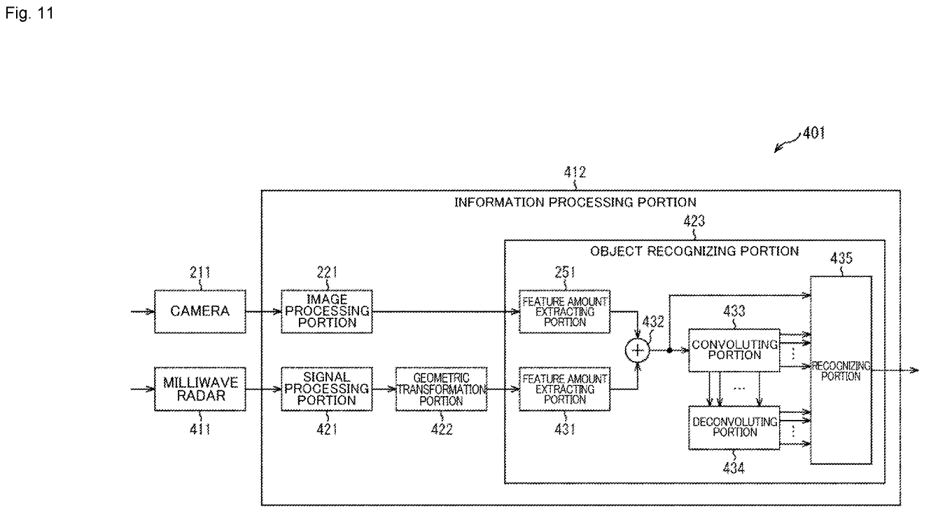

A third embodiment of the present technique will be described next with reference to FIG. 11.

### Information Processing System 401

FIG. 11 shows a configuration example of an information processing system 401 being a second embodiment of the information processing system to which the present technique is applied. In the diagram, the same reference signs are given to portions corresponding to the information processing system 201 shown in FIG. 3 and to the object recognizing portion 222A shown in FIG. 4 and descriptions thereof will be appropriately omitted.

The information processing system 401 includes the camera 211, a milliwave radar 411, and an information processing portion 412. The information processing portion 412 includes the image processing portion 221, a signal processing portion 421, a geometric transformation portion 422, and an object recognizing portion 423.

The object recognizing portion 423 constitutes, for example, a part of the recognizing portion 73 shown in FIG. 1, performs object recognition in the front of the vehicle 1 using a CNN, and outputs data representing a recognition result. The object recognizing portion 423 is generated by performing machine learning in advance. The object recognizing portion 423 includes the feature amount extracting portion 251, a feature amount extracting portion 431, a synthesizing portion 432, a convoluting portion 433, a deconvoluting portion 434, and a recognizing portion 435.

The milliwave radar 411 constitutes, for example, a part of the radar 52 shown in FIG. 1, performs sensing in the front of the vehicle 1, and at least a part of a sensing range overlaps with that of the camera 211. For example, the milliwave radar 411 transmits a transmission signal made up of milliwaves to the front of the vehicle 1 and receives, with a receiving antenna, a reception signal being a signal reflected by an object (a reflecting body) in the front of the vehicle 1. The receiving antenna is, for example, provided in plurality at predetermined intervals in a traverse direction (width direction) of the vehicle 1. In addition, receiving antennas may also be provided in plurality in a height direction. The milliwave radar 411 supplies the signal processing portion 421 with data (hereinafter, referred to as milliwave data) representing, in a time series, intensity of the reception signal having been received by each receiving antenna.

By performing predetermined signal processing on the milliwave data, the signal processing portion 421 generates a milliwave image being an image representing a sensing result of the milliwave radar 411. For example, the signal processing portion 421 generates two kinds of milliwave images: a signal intensity image and a velocity image. The signal intensity image is a milliwave image representing a position of each object in the front of the vehicle and an intensity of a signal (reception signal) reflected by each object. The velocity image is a milliwave image representing a position of each object in the front of the vehicle and a relative velocity of each object with respect to the vehicle 1.

The geometric transformation portion 422 transforms a milliwave image into an image in a same coordinate system as a photographed image by performing a geometric transformation of the milliwave image. In other words, the geometric transformation portion 422 transforms a milliwave image into an image (hereinafter, referred to as a geometrically-transformed milliwave image) viewed from a same point of view as a photographed image. More specifically, the geometric transformation portion 422 transforms a coordinate system of a signal intensity image and a velocity image from a coordinate system of a milliwave image into a coordinate system of a photographed image. Hereinafter, a signal intensity image and a velocity image after geometric transformation will be referred to as a geometrically-transformed signal intensity image and a geometrically-transformed velocity image. The geometric transformation portion 422 supplies the feature amount extracting portion 431 with the geometrically-transformed signal intensity image and the geometrically-transformed velocity image.

The feature amount extracting portion 431 is constituted of, for example, a feature amount extraction model such as VGG-16 in a similar manner to the feature amount extracting portion 251. The feature amount extracting portion 431 extracts a feature amount of a geometrically-transformed signal intensity image and generates a feature map (hereinafter, referred to as a signal intensity image feature map) which represents a distribution of feature amounts in two dimensions. In addition, the feature amount extracting portion 431 extracts a feature amount of a geometrically-transformed velocity image and generates a feature map (hereinafter, referred to as a velocity image feature map) which represents a distribution of feature amounts in two dimensions. The feature amount extracting portion 431 supplies the synthesizing portion 432 with the signal intensity image feature map and the velocity image feature map.

The synthesizing portion 432 generates a synthesized feature map by synthesizing the photographed image feature map, the signal intensity image feature map, and the velocity image feature map by addition, multiplication, or the like. The synthesizing portion 432 supplies the convoluting portion 433 and the recognizing portion 435 with the synthesized feature map.

The convoluting portion 433, the deconvoluting portion 434, and the recognizing portion 435 have similar functions to the convoluting portion 252, the deconvoluting portion 253, and the recognizing portion 254 shown in FIG. 4 or the convoluting portion 252, the deconvoluting portion 301, and the recognizing portion 302 shown in FIG. 8. In addition, the convoluting portion 433, the deconvoluting portion 434, and the recognizing portion 435 performs object recognition in the front of the vehicle 1 based on the synthesized feature map.

As described above, since object recognition is performed by also using milliwave data obtained by the milliwave radar 411 in addition to a photographed image obtained by the camera 211, recognition accuracy further improves.

### 5. Fourth Embodiment

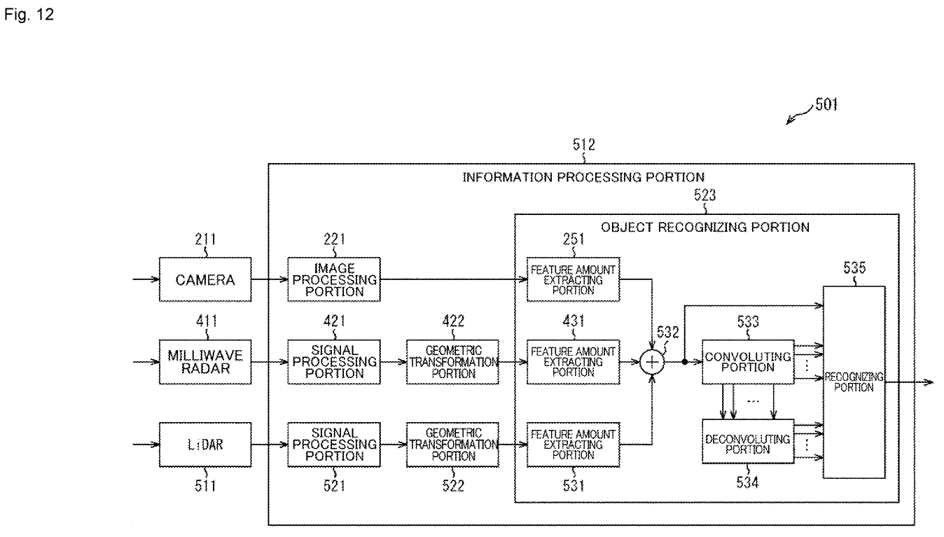

A fourth embodiment of the present technique will be described next with reference to FIG. 12.

### Configuration Example of Information Processing System 501

FIG. 12 shows a configuration example of an information processing system 501 being a third embodiment of the information processing system to which the present technique is applied. In the drawing, same reference signs are given to portions corresponding to the information processing system 401 shown in FIG. 11 and a description thereof will be appropriately omitted.

The information processing system 501 includes the camera 211, the milliwave radar 411, LiDAR 511, and an information processing portion 512. The information processing portion 512 includes the image processing portion 221, the signal processing portion 421, the geometric transformation portion 422, a signal processing portion 521, a geometric transformation portion 522, and an object recognizing portion 523.

The object recognizing portion 523 constitutes, for example, a part of the recognizing portion 73 shown in FIG. 1, performs object recognition in the front of the vehicle 1 using a CNN, and outputs data representing a recognition result. The object recognizing portion 523 is generated by performing machine learning in advance. The object recognizing portion 523 includes the feature amount extracting portion 251, the feature amount extracting portion 431, a feature amount extracting portion 531, a synthesizing portion 532, a convoluting portion 533, a deconvoluting portion 534, and a recognizing portion 535.

The LiDAR 511 constitutes, for example, a part of the LiDAR 53 shown in FIG. 1, performs sensing in the front of the vehicle 1, and at least a part of a sensing range overlaps with that of the camera 211. For example, the LiDAR 511 scans the front of the vehicle 1 with a laser pulse in a traverse direction and a height direction and receives reflected light of the laser pulse. Based on a time required to receive the reflected light, the LiDAR 511 calculates a distance to an object in front of the vehicle 1 and generates three-dimensional point group data (point cloud) representing a shape and a position of the object in front of the vehicle 1. The LiDAR 511 supplies the signal processing portion 521 with the point group data.

The signal processing portion 521 performs predetermined signal processing (for example, interpolation processing or thinning processing) on the point group data and supplies the geometric transformation portion 522 with the point group data after signal processing.

The geometric transformation portion 522 generates a two-dimensional image in a same coordinate system as a photographed image (hereinafter, referred to as two-dimensional point group data) by performing geometric transformation of the point group data. The geometric transformation portion 522 supplies the feature amount extracting portion 531 with the two-dimensional point group data.

The feature amount extracting portion 531 is constituted of, for example, a feature amount extraction model such as VGG-16 in a similar manner to the feature amount extracting portion 251 and the feature amount extracting portion 431. The feature amount extracting portion 531 extracts a feature amount of the two-dimensional point group data and generates a feature map (hereinafter, referred to as a point group data feature map) which represents a distribution of feature amounts in two dimensions. The feature amount extracting portion 531 supplies the synthesizing portion 532 with the point group data feature map.

The synthesizing portion 532 generates a synthesized feature map by synthesizing the photographed image feature map supplied from the feature amount extracting portion 251, the signal intensity image feature map and the velocity image feature map supplied from the feature amount extracting portion 431, and the point group data feature map supplied from the feature amount extracting portion 531 by addition, multiplication, or the like. The synthesizing portion 532 supplies the convoluting portion 533 and the recognizing portion 535 with the synthesized feature map.

The convoluting portion 533, the deconvoluting portion 534, and the recognizing portion 535 have similar functions to the convoluting portion 252, the deconvoluting portion 253, and the recognizing portion 254 shown in FIG. 4 or the convoluting portion 252, the deconvoluting portion 301, and the recognizing portion 302 shown in FIG. 8. In addition, the convoluting portion 533, the deconvoluting portion 534, and the recognizing portion 535 performs object recognition in the front of the vehicle 1 based on the synthesized feature map.

As described above, since object recognition is performed by also using point group data obtained by the LiDAR 511 in addition to a photographed image obtained by the camera 211 and milliwave data obtained by the milliwave radar 411, recognition accuracy further improves.

### 6. Fifth Embodiment

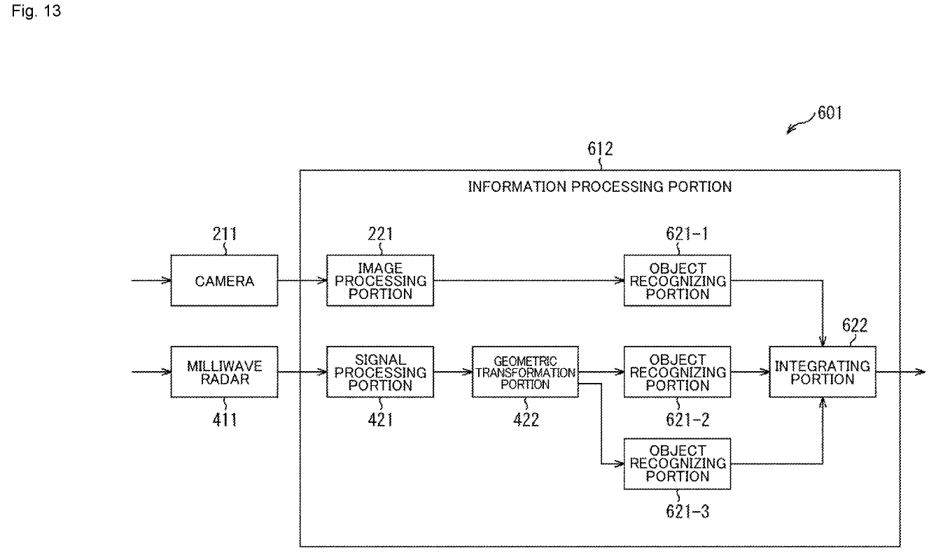

A fifth embodiment of the present technique will be described next with reference to FIG. 13.

### Configuration Example of Information Processing System 601

FIG. 13 shows a configuration example of an information processing system 601 being a fourth embodiment of the information processing system to which the present technique is applied. In the drawing, same reference signs are given to portions corresponding to the information processing system 401 shown in FIG. 11 and a description thereof will be appropriately omitted.

The information processing system 601 is the same as the information processing system 401 in that the information processing system 601 includes the camera 211 and the milliwave radar 411 but differs from the information processing system 401 in that the information processing system 601 includes an information processing portion 612 instead of the information processing portion 412. The information processing portion 612 is the same as the information processing portion 412 in that the information processing portion 612 includes the image processing portion 221, the signal processing portion 421, and the geometric transformation portion 422. On the other hand, the information processing portion 612 differs from the information processing portion 412 in that the information processing portion 612 includes object recognizing portions 621-1 to 621-3 and an integrating portion 622 but does not include the object recognizing portion 423.

The object recognizing portions 621-1 to 621-3 have similar functions to the object recognizing portion 222A shown in FIG. 4 or the object recognizing portion 222B shown in FIG. 8.

The object recognizing portion 621-1 performs object recognition based on a photographed image supplied from the image processing portion 221 and supplies the integrating portion 622 with data representing a recognition result.

The object recognizing portion 621-2 performs object recognition based on a geometrically-transformed signal intensity image supplied from the geometric transformation portion 422 and supplies the integrating portion 622 with data representing a recognition result.

The object recognizing portion 621-3 performs object recognition based on a geometrically-transformed velocity image supplied from the geometric transformation portion 422 and supplies the integrating portion 622 with data representing a recognition result.

The integrating portion 622 integrates recognition results of objects by the object recognizing portions 621-1 to 621-3. For example, objects recognized by the object recognizing portions 621-1 to 621-3 are selected (or not selected) based on reliability or the like. The integrating portion 622 outputs data representing an integrated recognition result.

As described above, since object recognition is performed by also using milliwave data obtained by the milliwave radar 411 in addition to a photographed image obtained by the camera 211 in a similar manner to the third embodiment, recognition accuracy further improves.

For example, the LiDAR 511, the signal processing portion 521, and the geometric transformation portion 522 shown in FIG. 12 and an object recognizing portion 621-4 (not illustrated) which performs object recognition based on two-dimensional point group data may be added. In addition, the integrating portion 622 may be configured to integrate recognition results of objects by the object recognizing portions 621-1 to 621-4 and output data representing an integrated recognition result.

### 7. Modifications

Hereinafter, modifications of the foregoing embodiments of the present technique will be described.

For example, object recognition need not necessarily be performed in all layers by combining a convolutional feature map and a deconvolutional feature map. In other words, in a part of the layers, object recognition may be performed based on only a photographed image feature map or a convolutional feature map.

For example, deconvolution of a convolutional feature map of all layers need not necessarily be performed. In other words, deconvolution may be performed only on the convolutional feature map of a part of the layers and object recognition may be performed based on a generated deconvolutional feature map.

For example, when object recognition is to be performed based on a synthesized feature map obtained by synthesizing a convolutional feature map and a deconvolutional feature map of a same layer, a deconvolutional feature map obtained by performing a deconvolution of the synthesized feature map may be used in object recognition of a next frame.

For example, frames of a convolutional feature map and a deconvolutional feature map to be combined in object recognition need not necessarily be adjacent to each other. For example, object recognition may be performed by combining a convolutional feature map based on a photographed image of a present frame and a deconvolutional feature map based on a photographed image of a frame preceding the present by two or more frames.

For example, a photographed image feature map prior to convolution may be prevented from being used in object recognition.

For example, the present technique can also be applied to a case where object recognition is performed by combining the camera 211 and the LiDAR 511.

For example, the present technique can also be applied to a case of using a sensor that detects an object other than a milliwave radar and LiDAR.

The present technique can also be applied to object recognition for applications other than the vehicle-mounted application described above.

For example, the present technique can also be applied to a case of recognizing an object in a periphery of a mobile body other than a vehicle. For example, mobile bodies such as a motorcycle, a bicycle, personal mobility, an airplane, an ocean vessel, construction machinery, and agricultural and farm machinery (a tractor) are assumed. In addition, mobile bodies to which the present technique can be applied include mobile bodies which are not boarded by a user and which are remotely driven (operated) such as drones and robots.

For example, the present technique can also be applied to a case where object recognition is performed at a fixed location such as a monitoring system.

In addition, types and the number of objects to be recognition targets in the present technique are not particularly limited.

Furthermore, a learning method of a CNN constituting an object recognizing portion is not particularly limited.

### 8. Others

### Configuration Example of Computer

The above-described series of processing can also be performed by hardware or software. When the series of processing is to be performed by software, a program constituting the software is installed in a computer. Here, the computer includes a computer incorporated into dedicated hardware or, for example, a general-purpose personal computer capable of executing various functions by installing various programs.

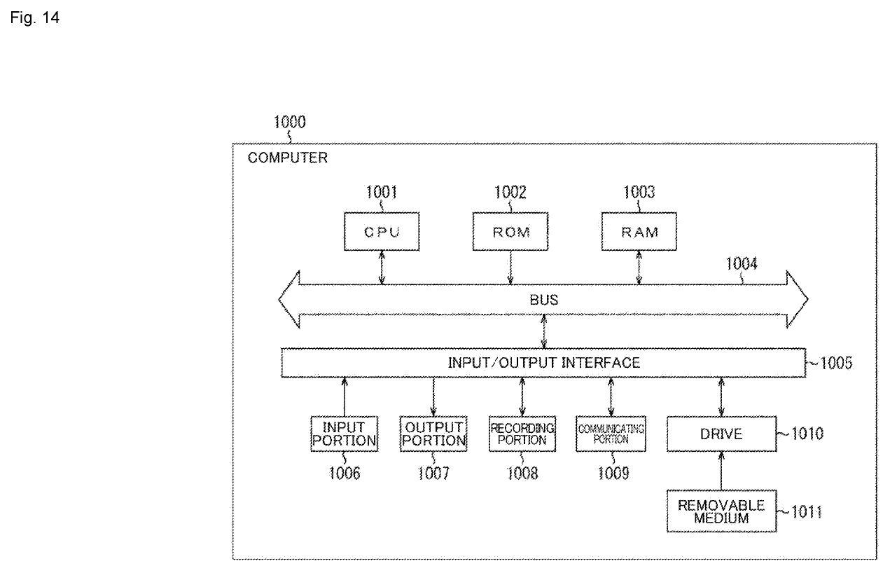

FIG. 14 is a block diagram showing an example of a hardware configuration of a computer that executes the above-described series of processing according to a program.

In a computer 1000, a CPU (Central Processing Unit) 1001, a ROM (Read Only Memory) 1002, and a RAM (Random Access Memory) 1003 are connected to each other by a bus 1004.

An input/output interface 1005 is further connected to the bus 1004. An input portion 1006, an output portion 1007, a recording portion 1008, a communicating portion 1009, and a drive 1010 are connected to the input/output interface 1005.

The input portion 1006 is constituted of an input switch, a button, a microphone, an imaging element, or the like. The output portion 1007 is constituted of a display, a speaker, or the like. The recording portion 1008 is constituted of a hard disk, a nonvolatile memory, or the like. The communicating portion 1009 is constituted of a network interface or the like. The drive 1010 drives a removable medium 1011 such as a magnetic disk, an optical disc, a magneto-optical disk, or a semiconductor memory.

In the computer 1000 configured as described above, for example, the CPU 1001 loads a program recorded in the recording portion 1008 into the RAM 1003 via the input/output interface 1005 and the bus 1004 and executes the program to perform the series of processing described above.

The program executed by the computer 1000 (CPU 1001) may be recorded on, for example, the removable medium 1011 as a package medium or the like so as to be provided. The program can also be provided via a wired or wireless transmission medium such as a local area network, the Internet, or digital satellite broadcasting.

In the computer 1000, the program may be installed in the recording portion 1008 via the input/output interface 1005 by inserting the removable medium 1011 into the drive 1010. Furthermore, the program can be received by the communicating portion 1009 via a wired or wireless transfer medium to be installed in the recording portion 1008. In addition, the program may be installed in advance in the ROM 1002 or the recording portion 1008.

Note that the program executed by a computer may be a program that performs processing chronologically in the order described in the present specification or may be a program that performs processing in parallel or at a necessary timing such as a called time.

In the present specification, a system means a set of a plurality of constituent elements (apparatuses, modules (components), or the like) and all the constituent elements may or may not be included in a same casing. Accordingly, a plurality of apparatuses accommodated in separate casings and connected to each other via a network and one apparatus in which a plurality of modules are accommodated in one casing both constitute systems.

Furthermore, embodiments of the present technique are not limited to the above-mentioned embodiments and various modifications may be made without departing from the gist of the present technique.

For example, the present technique may be configured as cloud computing in which a plurality of apparatuses share and cooperatively process one function via a network.

In addition, each step described in the above flowchart can be executed by one apparatus or executed in a shared manner by a plurality of apparatuses.

Furthermore, in a case where one step includes a plurality of processing steps, the plurality of processing steps included in the one step can be executed by one apparatus or executed in a shared manner by a plurality of apparatuses.

### Examples of Configuration Combinations

The present technique can also have the following configuration.

(1) An information processing apparatus, including:
a convoluting portion configured to perform, a plurality of times, convolution of an image feature map representing a feature amount of an image and to generate a convolutional feature map of a plurality of layers;
a deconvoluting portion configured to perform deconvolution of a feature map based on the convolutional feature map and to generate a deconvolutional feature map; and
a recognizing portion configured to perform object recognition based on the convolutional feature map and the deconvolutional feature map, wherein
the convoluting portion is configured to perform, a plurality of times, convolution of the image feature map representing a feature amount of an image of a first frame and to generate the convolutional feature map of a plurality of layers;
the deconvoluting portion is configured to perform deconvolution of a feature map based on the convolutional feature map based on an image of a second frame preceding the first frame and to generate the deconvolutional feature map, and the recognizing portion is configured to perform object recognition based on the convolutional feature map based on an image of the first frame and on the deconvolutional feature map based on an image of the second frame.

The information processing apparatus according to (1), wherein the recognizing portion is configured to perform object recognition by combining a first convolutional feature map based on an image of the first frame and a first deconvolutional feature map which is based on an image of the second frame and of which a layer is the same as the first convolutional feature map.

The information processing apparatus according to (2), wherein the deconvoluting portion is configured to generate, based on an image of the second frame, the first deconvolutional feature map by performing deconvolution of a feature map based on a second convolutional feature map which is deeper by n-number (n ≥ 1) of layers than the first convolutional feature map n-number of times.

The information processing apparatus according to (3), wherein
the deconvoluting portion is configured to further generate, based on an image of the second frame, a second deconvolutional feature map by performing deconvolution of a feature map based on a third convolutional feature map which is deeper by m-number (m ≥ 1, m ≠ n) of layers than the first convolutional feature map m-number of times, and
the recognizing portion is configured to perform object recognition by further combining the second deconvolutional feature map.

The information processing apparatus according to (3) or (4), wherein
the second frame is a frame immediately preceding the first frame,
n = 1 is satisfied,
the deconvoluting portion is configured to further generate a third deconvolutional feature map by performing deconvolution, once, of a second deconvolutional feature map which is one layer deeper than the first convolutional feature map and which is used in object recognition of an image of the second frame, and
the recognizing portion is configured to perform object recognition by further combining the third deconvolutional feature map.

The information processing apparatus according to any of (2) to (5), wherein the recognizing portion is configured to perform object recognition based on a synthesized feature map obtained by synthesizing the first convolutional feature map and the first deconvolutional feature map.

The information processing apparatus according to (6), wherein the deconvoluting portion is configured to generate the first deconvolutional feature map by performing deconvolution of the synthesized feature map which is used in object recognition of an image of the second frame and which is one layer deeper than the first deconvolutional feature map.

The information processing apparatus according to any of (1) to (7), wherein the convoluting portion and the deconvoluting portion are configured to perform processing in parallel.

The information processing apparatus according to any of (1) to (8), wherein the recognizing portion is configured to perform object recognition further based on the image feature map.

The information processing apparatus according to any of (1) to (9), further including a feature amount extracting portion configured to generate the image feature map.

The information processing apparatus according to any of (1) to (10), further including:
a first feature amount extracting portion configured to extract a feature amount of a photographed image obtained by a camera and to generate a first image feature map;
a second feature amount extracting portion configured to extract a feature amount of a sensor image representing a sensing result of a sensor of which a sensing range at least partially overlaps with a photographing range of the camera and to generate a second image feature map; and
a synthesizing portion configured to generate a synthesized image feature map being the image feature map obtained by synthesizing the first image feature map and the second image feature map, wherein
the convoluting portion is configured to perform convolution of the synthesized image feature map.

The information processing apparatus according to (11), further including: a geometric transformation portion configured to transform a first sensor image representing the sensing result according to a first coordinate system into a second sensor image representing the sensing result according to a second coordinate system,

wherein the second feature amount extracting portion is configured to extract a feature amount of the second sensor image and to generate the second image feature map.

The information processing apparatus according to (11), wherein the sensor is a milliwave radar or LiDAR (Light Detection and Ranging).

The information processing apparatus according to any of (1) to (10), further including:
a first feature amount extracting portion configured to extract a feature amount of a photographed image obtained by a camera and to generate a first image feature map;
a second feature amount extracting portion configured to extract a feature amount of a sensor image representing a sensing result of a sensor of which a sensing range at least partially overlaps with a photographing range of the camera and to generate a second image feature map;
a first recognizing portion which includes the convoluting portion, the deconvoluting portion, and the recognizing portion and which is configured to perform object recognition based on the first image feature map;
a second recognizing portion which includes the convoluting portion, the deconvoluting portion, and the recognizing portion and which is configured to perform object recognition based on the second image feature map; and an integrating portion configured to integrate a recognition result of an object by the first recognizing portion and a recognition result of an object by the second recognizing portion.

The information processing apparatus according to (14), wherein the sensor is a milliwave radar or LiDAR (Light Detection and Ranging).

The information processing apparatus according to any of (1) to (6) and (8) to (15),

wherein a feature map based on the convolutional feature map is the convolutional feature map itself.

The information processing apparatus according to any of (1) to (16), wherein the first frame and the second frame are adjacent frames.

An information processing method, including the steps of:
performing, a plurality of times, convolution of an image feature map representing a feature amount of an image of a first frame and generating a convolutional feature map of a plurality of layers;
performing deconvolution of a feature map based on the convolutional feature map based on an image of a second frame preceding the first frame and generating a deconvolutional feature map; and
performing object recognition based on the convolutional feature map based on an image of the first frame and on the deconvolutional feature map based on an image of the second frame.

A program for causing a computer to execute processing of:
performing, a plurality of times, convolution of an image feature map representing a feature amount of an image of a first frame and generating a convolutional feature map of a plurality of layers;
performing deconvolution of a feature map based on the convolutional feature map based on an image of a second frame preceding the first frame and generating a deconvolutional feature map; and
performing object recognition based on the convolutional feature map based on an image of the first frame and on the deconvolutional feature map based on an image of the second frame.

The advantageous effects described in the present specification are merely exemplary and are not limited, and other advantageous effects may be obtained.

Reference Signs List
1 Vehicle
11 Vehicle control system
51 Camera
52 Radar
53 LiDAR
72 Sensor fusion portion
73 Recognizing portion
201 Information processing system
211 Camera
221 Image processing portion
212 Information processing portion
222, 222A, 222B Object recognizing portion
251 Feature amount extracting portion
252 Convoluting portion
253 Deconvoluting portion
254 Recognizing portion
301 Deconvoluting portion
302 Recognizing portion
401 Information processing system
411 Milliwave radar
412 Information processing portion
421 Signal processing portion
422 Geometric transformation portion
423 Object recognizing portion
431 Feature amount extracting portion
432 Synthesizing portion
433 Convolutional layer
434 Deconvolutional layer
435 Recognizing portion
501 Information processing system
511 LiDAR
512 Information processing portion
521 Signal processing portion
522 Geometric transformation portion
523 Object recognizing portion
531 Feature amount extracting portion
532 Synthesizing portion
533 Convolutional layer
534 Deconvolutional layer
535 Recognizing portion
601 Information processing system
621-1 to 621-3 Object recognizing portion
622 Integrating portion

1. An information processing apparatus, comprising:
a convoluting portion configured to perform, a plurality of times, convolution of an image feature map representing a feature amount of an image and to generate a convolutional feature map of a plurality of layers;
a deconvoluting portion configured to perform deconvolution of a feature map based on the convolutional feature map and to generate a deconvolutional feature map; and
a recognizing portion configured to perform object recognition based on the convolutional feature map and the deconvolutional feature map, wherein
the convoluting portion is configured to perform, a plurality of times, convolution of the image feature map representing a feature amount of an image of a first frame and to generate the convolutional feature map of a plurality of layers;
the deconvoluting portion is configured to perform deconvolution of a feature map based on the convolutional feature map based on an image of a second frame preceding the first frame and to generate the deconvolutional feature map, and the recognizing portion is configured to perform object recognition based on the convolutional feature map based on an image of the first frame and on the deconvolutional feature map based on an image of the second frame.

2. The information processing apparatus according to claim 1, wherein
the recognizing portion is configured to perform object recognition by combining a first convolutional feature map based on an image of the first frame and a first deconvolutional feature map which is based on an image of the second frame and of which a layer is the same as the first convolutional feature map.

3. The information processing apparatus according to claim 2, wherein
the deconvoluting portion is configured to generate, based on an image of the second frame, the first deconvolutional feature map by performing deconvolution of a feature map based on a second convolutional feature map which is deeper by n-number (n ≥ 1) of layers than the first convolutional feature map n-number of times.

4.
The information processing apparatus according to claim 3, wherein
the deconvoluting portion is configured to further generate, based on an image of the second frame, a second deconvolutional feature map by performing deconvolution of a feature map based on a third convolutional feature map which is deeper by m-number (m ≥ 1, m ≠ n) of layers than the first convolutional feature map m-number of times, and
the recognizing portion is configured to perform object recognition by further combining the second deconvolutional feature map.

5. The information processing apparatus according to claim 3, wherein
the second frame is a frame immediately preceding the first frame,
n = 1 is satisfied,
the deconvoluting portion is configured to further generate a third deconvolutional feature map by performing deconvolution, once, of a second deconvolutional feature map which is one layer deeper than the first convolutional feature map and which is used in object recognition of an image of the second frame, and the recognizing portion is configured to perform object recognition by further combining the third deconvolutional feature map.

6. The information processing apparatus according to claim 2, wherein
the recognizing portion is configured to perform object recognition based on a synthesized feature map obtained by synthesizing the first convolutional feature map and the first deconvolutional feature map.

7. The information processing apparatus according to claim 6, wherein
the deconvoluting portion is configured to generate the first deconvolutional feature map by performing deconvolution of the synthesized feature map which is used in object recognition of an image of the second frame and which is one layer deeper than the first deconvolutional feature map.

8. The information processing apparatus according to claim 1, wherein
the convoluting portion and the deconvoluting portion are configured to perform processing in parallel.

9. The information processing apparatus according to claim 1, wherein
the recognizing portion is configured to perform object recognition further based on the image feature map.

10. The information processing apparatus according to claim 1, further comprising
a feature amount extracting portion configured to generate the image feature map.

11. The information processing apparatus according to claim 1, further comprising:
a first feature amount extracting portion configured to extract a feature amount of a photographed image obtained by a camera and to generate a first image feature map;
a second feature amount extracting portion configured to extract a feature amount of a sensor image representing a sensing result of a sensor of which a sensing range at least partially overlaps with a photographing range of the camera and to generate a second image feature map; and
a synthesizing portion configured to generate a synthesized image feature map being the image feature map obtained by synthesizing the first image feature map and the second image feature map, wherein
the convoluting portion is configured to perform convolution of the synthesized image feature map.

12. The information processing apparatus according to claim 11, further comprising:
a geometric transformation portion configured to transform a first sensor image representing the sensing result according to a first coordinate system into a second sensor image representing the sensing result according to a second coordinate system, wherein
the second feature amount extracting portion is configured to extract a feature amount of the second sensor image and to generate the second image feature map.

13. The information processing apparatus according to claim 11, wherein the sensor is a milliwave radar or LiDAR (Light Detection and Ranging).

14. The information processing apparatus according to claim 1, further comprising:
a first feature amount extracting portion configured to extract a feature amount of a photographed image obtained by a camera and to generate a first image feature map;
a second feature amount extracting portion configured to extract a feature amount of a sensor image representing a sensing result of a sensor of which a sensing range at least partially overlaps with a photographing range of the camera and to generate a second image feature map;
a first recognizing portion which includes the convoluting portion, the deconvoluting portion, and the recognizing portion and which is configured to perform object recognition based on the first image feature map;
a second recognizing portion which includes the convoluting portion, the deconvoluting portion, and the recognizing portion and which is configured to perform object recognition based on the second image feature map; and an integrating portion configured to integrate a recognition result of an object by the first recognizing portion and a recognition result of an object by the second recognizing portion.

15. The information processing apparatus according to claim 14, wherein the sensor is a milliwave radar or LiDAR (Light Detection and Ranging).

16. The information processing apparatus according to claim 1, wherein
a feature map based on the convolutional feature map is the convolutional feature map itself.

17. The information processing apparatus according to claim 1, wherein
the first frame and the second frame are adjacent frames.

18. An information processing method, comprising the steps of:
performing, a plurality of times, convolution of an image feature map representing a feature amount of an image of a first frame and generating a convolutional feature map of a plurality of layers;
performing deconvolution of a feature map based on the convolutional feature map based on an image of a second frame preceding the first frame and generating a deconvolutional feature map; and
performing object recognition based on the convolutional feature map based on an image of the first frame and on the deconvolutional feature map based on an image of the second frame.

19. A program for causing a computer to execute processing of:
performing, a plurality of times, convolution of an image feature map representing a feature amount of an image of a first frame and generating a convolutional feature map of a plurality of layers;
performing deconvolution of a feature map based on the convolutional feature map based on an image of a second frame preceding the first frame and generating a deconvolutional feature map; and
performing object recognition based on the convolutional feature map based on an image of the first frame and on the deconvolutional feature map based on an image of the second frame.
